(19) United States
(12) Patent Application Publication
(10) Pub. No.: US 2026/0244004 A1
(43) Pub. Date: Aug. 20, 2026

(54) OPTICAL SYSTEM, OPTICAL APPARATUS, AND METHOD FOR MANUFACTURING OPTICAL SYSTEM

(71) Applicant: NIKON CORPORATION, Shinagawa-ku, Tokyo (JP)

(72) Inventor: Keigo KOIDA, Kawasaki-shi (JP)

(21) Appl. No.: 19/159,353

(22) PCT Filed: Mar. 8, 2024
(86) PCT No.: PCT/JP2024/009075

§ 371 Date: Aug. 25, 2025

(30) Foreign Application Priority Data
Mar. 27, 2023 (JP) 2023-049774

(51) Int. Cl. G02B 13/18; G02B 13/22; G02B 27/00

(52) U.S. Cl. CPC G02B 13/18; G02B 13/22; G02B 27/005

(57) ABSTRACT

An optical system having an image pickup magnification of 0.5× or more and capable of ensuring favorable optical performance while achieving weight and size reduction, an optical apparatus, and a method for manufacturing the optical system are provided.

An optical system OL included in an optical apparatus such as a camera 1 includes a front group GF, an intermediate group GM, and a rear group GR sequentially from an object side, the intermediate group GM moves in an optical axis direction at focusing, and the optical system OL satisfies a condition expressed by an expression below,

$$0.54 < d 1 / f < 1.$$

in the expression,
d1: distance on an optical axis from a lens surface closest to an image plane side in the front group GF to a lens surface closest to the object side in the intermediate group GM at focusing on an infinite distance object, and
f: overall focal length of the optical system OL at focusing on an infinite distance object.

### TECHNICAL FIELD

The present invention relates to an optical system, an optical apparatus, and a method for manufacturing the optical system.

### BACKGROUND ART

Conventionally, a small-sized and lightweight macro lens has been disclosed (refer to Patent Literature 1, for example). However, further improvement of optical performance is required.

### CITATION LIST

### Patent Literature

Patent Literature 1: Japanese Patent Laid-open No. 2021-148808

### SUMMARY OF INVENTION

An optical system according to a first aspect of the present invention includes a front group, an intermediate group, and a rear group sequentially from an object side, the intermediate group moves in an optical axis direction at focusing, and the optical system satisfies a condition expressed by an expression below,

$$0.54 < d 1 / f < 1.00$$

in the expression,
d1: distance on an optical axis from a lens surface closest to an image plane side in the front group to a lens surface closest to the object side in the intermediate group at focusing on an infinite distance object, and
f: overall focal length of the optical system at focusing on an infinite distance object.

An optical system according to a second aspect of the present invention includes a front group, an intermediate group, and a rear group sequentially from an object side, the intermediate group moves in an optical axis direction at focusing, and the optical system satisfies a condition expressed by expressions below,

$$32. < TL / DF < 80.$$

$$1. < DM / DR < 4.$$

in the expressions,
TL: optical total length of the optical system at focusing on an infinite distance object,
DF: distance on an optical axis from a lens surface closest to the object side to a lens surface closest to an image plane side in the front group,
DM: distance on the optical axis from a lens surface closest to the object side to a lens surface closest to the image plane side in the intermediate group at focusing on an infinite distance object, and
DR: distance on the optical axis from a lens surface closest to the object side to a lens surface closest to the image plane side in the rear group.

A method for manufacturing the optical system according to the first aspect of the present invention is a method for manufacturing an optical system including a front group, an intermediate group, and a rear group sequentially from an object side, the method including disposing the lens groups so that the intermediate group moves in an optical axis direction at focusing, and disposing the lens groups so that a condition expressed by an expression below is satisfied,

$$0.54 < d 1 / f < 1.$$

in the expression,
d1: distance on an optical axis from a lens surface closest to an image plane side in the front group to a lens surface closest to the object side in the intermediate group at focusing on an infinite distance object, and
f: overall focal length of the optical system at focusing on an infinite distance object.

A method for manufacturing the optical system according to the second aspect of the present invention is a method for manufacturing an optical system including a front group, an intermediate group, and a rear group sequentially from an object side, the method including disposing the lens groups so that the intermediate group moves in an optical axis direction at focusing, and disposing the lens groups so that a condition expressed by expressions below is satisfied,

$$32. < TL / DF < 80.$$

$$1. < DM / DR < 4.$$

in the expressions,
TL: optical total length of the optical system at focusing on an infinite distance object,
DF: distance on an optical axis from a lens surface closest to the object side to a lens surface closest to an image plane side in the front group,
DM: distance on the optical axis from a lens surface closest to the object side to a lens surface closest to the image plane side in the intermediate group at focusing on an infinite distance object, and
DR: distance on the optical axis from a lens surface closest to the object side to a lens surface closest to the image plane side in the rear group.

### BRIEF DESCRIPTION OF DRAWINGS

FIG. 1 is a cross-sectional view showing a lens configuration of an optical system according to a first example.

FIG. 2A is a variety of aberration diagram of the optical system according to the first example at focusing on an infinite distance object.

FIG. 2B is a variety of aberration diagram of the optical system according to the first example at focusing on a close distance object.

FIG. 3 is a cross-sectional view showing a lens configuration of an optical system according to a second example.

FIG. 4A is a variety of aberration diagram of the optical system according to the second example at focusing on an infinite distance object.

FIG. 4B is a variety of aberration diagram of the optical system according to the second example at focusing on a close distance object.

FIG. 5 is a cross-sectional view showing a lens configuration of an optical system according to a third example.

FIG. 6A is a variety of aberration diagram of the optical system according to the third example at focusing on an infinite distance object.

FIG. 6B is a variety of aberration diagram of the optical system according to the third example at focusing on a close distance object.

FIG. 7 is a cross-sectional view showing a lens configuration of an optical system according to a fourth example.

FIG. 8A is a variety of aberration diagram of the optical system according to the fourth example at focusing on an infinite distance object.

FIG. 8B is a variety of aberration diagram of the optical system according to the fourth example at focusing on a close distance object.

FIG. 9 is a cross-sectional view showing a lens configuration of an optical system according to a fifth example.

FIG. 10A is a variety of aberration diagram of the optical system according to the fifth example at focusing on an infinite distance object.

FIG. 10B is a variety of aberration diagram of the optical system according to the fifth example at focusing on a close distance object.

FIG. 11 is a cross-sectional view showing a lens configuration of an optical system according to a sixth example.

FIG. 12A is a variety of aberration diagram of the optical system according to the sixth example at focusing on an infinite distance object.

FIG. 12B is a variety of aberration diagram of the optical system according to the sixth example at focusing on a close distance object.

FIG. 13 is a cross-sectional view showing a lens configuration of an optical system according to a seventh example.

FIG. 14A is a variety of aberration diagram of the optical system according to the seventh example at focusing on an infinite distance object.

FIG. 14B is a variety of aberration diagram of the optical system according to the seventh example at focusing on a close distance object.

FIG. 15 is a cross-sectional view of a camera on which an above-described optical system is mounted.

FIG. 16 is a flowchart for description of a method for manufacturing the above-described optical system.

### DESCRIPTION OF EMBODIMENTS

Preferable embodiments will be described below with reference to the accompanying drawings.

### First Embodiment

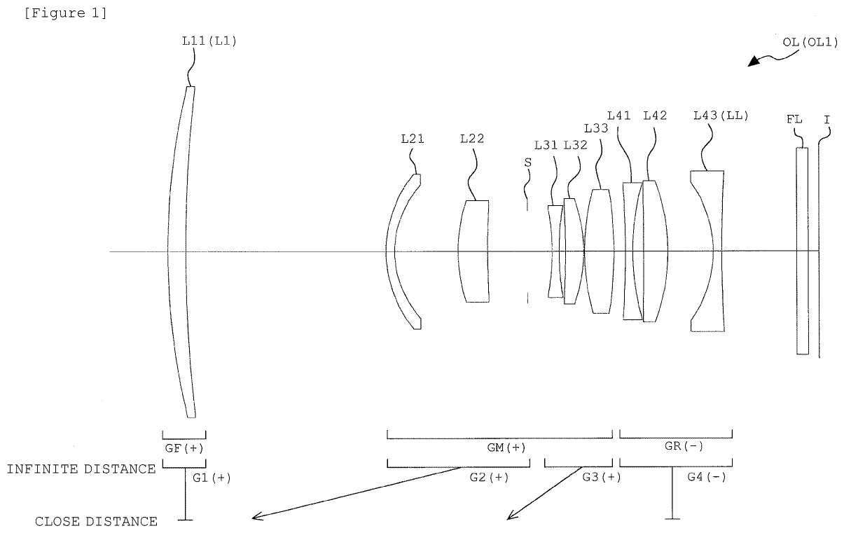

As shown in FIG. 1, an optical system OL according to a first embodiment includes a front group GF, an intermediate group GM, and a rear group GR sequentially from an object side, and the intermediate group GM moves in an optical axis direction at focusing. With this configuration, the optical system OL can have an image pickup magnification of 0.5× or more and ensure favorable optical performance while achieving weight and size reduction.

The optical system OL according to the first embodiment preferably satisfies Conditional Expression (1) shown below.

$$0.54 < d 1 / f < 1. \qquad ( 1 )$$

in the expression,
d1: distance on an optical axis from a lens surface closest to an image plane side in the front group GF to a lens surface closest to the object side in the intermediate group GM at focusing on an infinite distance object, and
f: overall focal length of the optical system OL at focusing on an infinite distance object.

Conditional Expression (1) defines the ratio of the distance on the optical axis from the lens surface closest to the image plane side in the front group GF to the lens surface closest to the object side in the intermediate group GM, in other words, the space between the front group GM and the intermediate group GM to the overall focal length of the optical system OL at focusing on an infinite distance object. By satisfying Conditional Expression (1), it is possible to achieve favorable aberration correction of the optical system OL at focusing while achieving weight and size reduction thereof and an image pickup magnification of 0.5× or more. When the upper limit value of Conditional Expression (1) is exceeded, it is possible to excellently correct spherical aberration, field curvature, coma aberration, and the like of the intermediate group GM at focusing, but it is difficult to achieve weight and size reduction of the optical system OL, and hence such a configuration is not preferable. Meanwhile, it is possible to secure the advantageous effect of the present embodiment more surely by setting the upper limit value of Conditional Expression (1) to 0.90. Further, in order to secure the advantageous effect of the present embodiment further more surely, it is preferable to set the upper limit value of Conditional Expression (1) to 0.85, 0.80, and more preferable to 0.75. Moreover, when the lower limit value of Conditional Expression (1) is exceeded, it is possible to achieve size reduction of the optical system OL, but it is difficult to correct spherical aberration, field curvature, coma aberration, and the like of the intermediate group GM at focusing, and hence such a configuration is not preferable. Meanwhile, it is possible to secure the advantageous effect of the present embodiment more surely by setting the lower limit value of Conditional Expression (1) to 0.58. Further, in order to secure the advantageous effect of the present embodiment further more surely, it is preferable to set the lower limit value of Conditional Expression (1) to 0.60, and more preferable to 0.63.

### Second Embodiment

As shown in FIG. 1, an optical system OL according to a second embodiment includes a front group GF, an intermediate group GM, and a rear group GR sequentially from an object side, and the intermediate group GM moves in an optical axis direction at focusing. With this configuration, the optical system OL can have an image pickup magnification of 0.5× or more and ensure favorable optical performance while achieving weight and size reduction.

The optical system OL according to the second embodiment preferably satisfies Conditional Expression (2) shown below.

$$32. < TL / DF < 80. \qquad ( 2 )$$

in the expression,
TL: optical total length (air-conversion length) of the optical system OL at focusing on an infinite distance object, and
DF: distance on the optical axis from a lens surface closest to the object side to a lens surface closest to the image plane side in the front group GF.

Conditional Expression (2) defines the ratio of the optical total length of the optical system OL at focusing on an infinite distance object to the distance on the optical axis from the lens surface closest to the object side to the lens surface closest to the image plane side in the front group GF (thickness of the front group GF on the optical axis). By satisfying Conditional Expression (2), it is possible to easily perform aberration correction of the optical system OL while achieving weight and size reduction thereof. When the upper limit value of Conditional Expression (2) is exceeded, the thickness of the front group GF on the optical axis (distance on the optical axis from the lens surface closest to the object side to the lens surface closest to the image plane side) is large for the optical total length of the optical system OL, and accordingly, it is possible to excellently correct spherical aberration, chromatic aberration, coma aberration, and the like, but field curvature, astigmatism, and coma aberration are significant at focusing when the optical total length of the optical system OL is too short, and hence such a configuration is not preferable. Meanwhile, it is possible to secure the advantageous effect of the present embodiment more surely by setting the upper limit value of Conditional Expression (2) to 75.00. Further, in order to secure the advantageous effect of the present embodiment further more surely, it is preferable to set the upper limit value of Conditional Expression (2) to 70.00. Moreover, when the lower limit value of Conditional Expression (2) is exceeded, the thickness of the front group GF on the optical axis is small for the optical total length of the optical system OL, and accordingly, it is possible to shorten the optical total length of the optical system OL, but aberration correction at the front group GF is insufficient and it is difficult to correct spherical aberration, coma aberration, field curvature, and the like, and hence such a configuration is not preferable. Meanwhile, it is possible to secure the advantageous effect of the present embodiment more surely by setting the lower limit value of Conditional Expression (2) to 33.50. Further, in order to secure the advantageous effect of the present embodiment further more surely, it is preferable to set the lower limit value of Conditional Expression (2) to 35.00.

The optical system OL according to the second embodiment preferably satisfies Conditional Expression (3) shown below.

$$1. < DM / DR < 4. \qquad ( 3 )$$

in the expression,
DM: distance on the optical axis from a lens surface closest to the object side to a lens surface closest to the image plane side in the intermediate group GM at focusing on an infinite distance object, and
DR: distance on the optical axis from a lens surface closest to the object side to a lens surface closest to the image plane side in the rear group GR.

Conditional Expression (3) defines the ratio of the distance on the optical axis from the lens surface closest to the object side to the lens surface closest to the image plane side in the intermediate group GM at focusing on an infinite distance object (thickness of the intermediate group GM on the optical axis) to the distance on the optical axis from the lens surface closest to the object side to the lens surface closest to the image plane side in the rear group GR (thickness of the rear group GR on the optical axis). By satisfying Conditional Expression (3), it is possible to excellently perform aberration correction of the optical system OL for brightness and the angle of view while achieving weight and size reduction thereof. When the upper limit value of Conditional Expression (3) is exceeded, the thickness of the intermediate group GM on the optical axis is large for the thickness of the rear group GR on the optical axis, it is possible to excellently correct spherical aberration, coma aberration, and the like, but it is difficult to correct aberration such as field curvature and astigmatism for the angle of view when the total length of the optical system OL is shortened, and hence such a configuration is not preferable. Meanwhile, it is possible to secure the advantageous effect of the present embodiment more surely by setting the upper limit value of Conditional Expression (3) to 3.50. Further, in order to secure the advantageous effect of the present embodiment further more surely, it is preferable to set the upper limit value of Conditional Expression (3) to 3.00, and more preferable to 2.50. Moreover, when the lower limit value of Conditional Expression (3) is exceeded, the thickness of the rear group GR on the optical axis is large for the thickness of the intermediate group GM on the optical axis, and accordingly, it is possible to excellently correct field curvature, astigmatism, and the like, but it is difficult to correct aberration for brightness, such as spherical aberration and coma aberration, when the total length of the optical system OL is short, and hence such a configuration is not preferable. Meanwhile, it is possible to secure the advantageous effect of the present embodiment more surely by setting the lower limit value of Conditional Expression (3) to 1.25. Further, in order to secure the advantageous effect of the present embodiment further more surely, it is preferable to set the lower limit value of Conditional Expression (3) to 1.50, and more preferable to 1.75.

The optical system OL according to the first and second embodiments (hereinafter referred to as “the present embodiment”) preferably satisfies Conditional Expression (4) shown below.

$$0.2 < d 1 / TL < 0.4 \qquad ( 4 )$$

in the expression,
d1: distance on the optical axis from the lens surface closest to the image plane side in the front group GF to the lens surface closest to the object side in the intermediate group GM at focusing on an infinite distance object, and
TL: optical total length (air-conversion length) of the optical system OL at focusing on an infinite distance object.

Conditional Expression (4) defines the ratio of the distance on the optical axis from the lens surface closest to the image plane side in the front group GF to the lens surface closest to the object side in the intermediate group GM (space between the front group GF and the intermediate group GM) to the optical total length of the optical system OL at focusing on an infinite distance object. By satisfying Conditional Expression (4), it is possible to excellently correct aberration of the optical system OL at focusing while achieving weight and size reduction thereof and an image pickup magnification of 0.5× or more. When the upper limit value of Conditional Expression (4) is exceeded, it is possible to excellently correct spherical aberration, field curvature, coma aberration, and the like of the intermediate group GM at focusing, but it is difficult to achieve size reduction of the optical system OL, and hence such a configuration is not preferable. Meanwhile, it is possible to secure the advantageous effect of the present embodiment more surely by setting the upper limit value of Conditional Expression (4) to 0.38. Further, in order to secure the advantageous effect of the present embodiment further more surely, it is preferable to set the upper limit value of Conditional Expression (4) to 0.35. Moreover, when the lower limit value of Conditional Expression (4) is exceeded, it is possible to achieve size reduction of the optical system OL, but it is difficult to correct spherical aberration, field curvature, coma aberration, and the like of the intermediate group GM at focusing, and hence such a configuration is not preferable. Meanwhile, it is possible to secure the advantageous effect of the present embodiment more surely by setting the lower limit value of Conditional Expression (4) to 0.23. Further, in order to secure the advantageous effect of the present embodiment further more surely, it is preferable to set the lower limit value of Conditional Expression (4) to 0.25.

The optical system OL according to the present embodiment preferably satisfies Conditional Expression (5) shown below.

$$17. < ( DF + DM + DR ) / DF < 40. \qquad ( 5 )$$

in the expression,
DF: distance on the optical axis from the lens surface closest to the object side to the lens surface closest to the image plane side in the front group GF,
DM: distance on the optical axis from the lens surface closest to the object side to the lens surface closest to the image plane side in the intermediate group GM at focusing on an infinite distance object, and
DR: distance on the optical axis from the lens surface closest to the object side to the lens surface closest to the image plane side in the rear group GR.

Conditional Expression (5) defines the ratio of the sum of the thicknesses of the front group GF, the intermediate group GM, and the rear group GR on the optical axis to the thickness of the front group GF on the optical axis. By satisfying Conditional Expression (5), it is possible to excellently correct field curvature, astigmatism, spherical aberration, coma aberration, and the like of the optical system OL. When the upper limit value of Conditional Expression (5) is exceeded, the thickness of the front group GF on the optical axis is small for the overall thickness (sum of the thicknesses of the front group GF, the intermediate group GM, and the rear group GR on the optical axis), and accordingly, it is possible to excellently correct spherical aberration, coma aberration, and the like of the optical system OL, but it is difficult to excellently correct field curvature, astigmatism, and the like, and hence such a configuration is not preferable. Meanwhile, it is possible to secure the advantageous effect of the present embodiment more surely by setting the upper limit value of Conditional Expression (5) to 39.00. Further, in order to secure the advantageous effect of the present embodiment further more surely, it is preferable to set the upper limit value of Conditional Expression (5) to 38.00, 37.00, and more preferable to 36.50. Moreover, when the lower limit value of Conditional Expression (5) is exceeded, the thickness of the front group GF on the optical axis is large for the overall thickness, and accordingly, it is possible to excellently correct field curvature, astigmatism, and the like of the optical system OL, but it is difficult to excellently correct spherical aberration, coma aberration, and the like, and hence such a configuration is not preferable. Meanwhile, it is possible to secure the advantageous effect of the present embodiment more surely by setting the lower limit value of Conditional Expression (5) to 17.50. Further, in order to secure the advantageous effect of the present embodiment further more surely, it is preferable to set the lower limit value of Conditional Expression (5) to 18.00, 18.50, and more preferable to 18.80.

The optical system OL according to the present embodiment preferably satisfies Conditional Expression (6) shown below.

$$0.8 < ( 1 - {βM}^{2} ) \times {βR}^{2} < 2. \qquad ( 6 )$$

in the expression,
βM: lateral magnification of the intermediate group GM at focusing on an infinite distance object, and
βR: lateral magnification of the rear group GR at focusing on an infinite distance object.

Conditional Expression (6) defines a condition for performing focusing with the intermediate group GM. By satisfying Conditional Expression (6), it is possible to achieve weight and size reduction of the optical system OL and reduce aberration variation at focusing while appropriately maintaining image plane position change at focusing. When the upper limit value of Conditional Expression (6) is exceeded, it is possible to achieve reduction of aberration variation of the optical system OL at focusing and size reduction thereof, but image plane position change at focusing is large, which limits selection of an actuator that operates the intermediate group GM as a focusing group, and hence such a configuration is not preferable. Meanwhile, it is possible to secure the advantageous effect of the present embodiment more surely by setting the upper limit value of Conditional Expression (6) to 1.90. Further, in order to secure the advantageous effect of the present embodiment further more surely, it is preferable to set the upper limit value of Conditional Expression (6) to 1.85, and more preferable to 1.80. Moreover, when the lower limit value of Conditional Expression (6) is exceeded, image plane position change of the optical system OL at focusing decreases and actuator selection is unlikely to be limited, which is thus preferable, but it is difficult to achieve reduction of aberration variation at focusing and size reduction, and hence such a configuration is not preferable. Meanwhile, it is possible to secure the advantageous effect of the present embodiment more surely by setting the lower limit value of Conditional Expression (6) to 0.90. Further, in order to secure the advantageous effect of the present embodiment further more surely, it is preferable to set the lower limit value of Conditional Expression (6) to 1.00, and more preferable to 1.10.

The optical system OL according to the present embodiment preferably satisfies Conditional Expression (7) shown below.

$$- 0.5 < f / fF < 0.3 \qquad ( 7 )$$

in the expression,
f: overall focal length of the optical system OL at focusing on an infinite distance object, and
fF: focal length of the front group GF.

Conditional Expression (7) defines the ratio of the overall focal length of the optical system OL at focusing on an infinite distance object to the focal length of the front group GF. By satisfying Conditional Expression (7), it is possible to excellently correct a variety of aberrations such as spherical aberration, coma aberration, field curvature, and astigmatism of the optical system OL and excellently reduce aberration variation at focusing. Meanwhile, it is possible to secure the advantageous effect of the present embodiment more surely by setting the upper limit value of Conditional Expression (7) to 0.25. Further, in order to secure the advantageous effect of the present embodiment further more surely, it is preferable to set the upper limit value of Conditional Expression (7) to 0.20, and more preferable to 0.15. Meanwhile, it is possible to secure the advantageous effect of the present embodiment more surely by setting the lower limit value of Conditional Expression (7) to −0.40. Further, in order to secure the advantageous effect of the present embodiment further more surely, it is preferable to set the lower limit value of Conditional Expression (7) to −0.30, and more preferable to −0.20.

In the optical system OL according to the present embodiment, a lens component LL disposed closest to the image plane side preferably has negative refractive power. With this configuration, it is possible to excellently correct field curvature and astigmatism of the optical system OL.

In the optical system OL according to the present embodiment, the front group GF is preferably constituted by one lens. With this configuration, it is possible to excellently reduce aberration variation at focusing while achieving weight and size reduction of the optical system OL.

The optical system OL according to the present embodiment preferably includes an aperture (for example, an aperture stop S in FIG. 1) in the intermediate group GM, and the aperture preferably moves in the optical axis direction at focusing. As the aperture moves in the optical axis direction together with the intermediate group GM at focusing, it is possible to excellently reduce variation of field curvature, astigmatism, and coma aberration at focusing.

In the optical system OL according to the present embodiment, the intermediate group GM preferably has positive refractive power. With this configuration, it is possible to excellently correct a variety of aberrations such as field curvature, spherical aberration, coma aberration, and distortion of the optical system OL.

In the optical system OL according to the present embodiment, the rear group GR preferably has negative refractive power. With this configuration, it is possible to excellently correct a variety of aberrations such as field curvature, spherical aberration, coma aberration, and distortion of the optical system OL.

The optical system OL according to the present embodiment preferably satisfies Conditional Expression (8) shown below.

$$0.5 < fM / f < 1.1 \qquad ( 8 )$$

in the expression,
fM: focal length of the intermediate group GM at focusing on an infinite distance object, and
f: overall focal length of the optical system OL at focusing on an infinite distance object.

Conditional Expression (8) defines the ratio of the focal length of the intermediate group GM to the overall focal length of the optical system OL at focusing on an infinite distance object. By satisfying Conditional Expression (8), it is possible to excellently correct spherical aberration, coma aberration, and the like of the optical system OL. Meanwhile, it is possible to secure the advantageous effect of the present embodiment more surely by setting the upper limit value of Conditional Expression (8) to 1.05. Further, in order to secure the advantageous effect of the present embodiment further more surely, it is preferable to set the upper limit value of Conditional Expression (8) to 1.00. Meanwhile, it is possible to secure the advantageous effect of the present embodiment more surely by setting the lower limit value of Conditional Expression (8) to 0.55. Further, in order to secure the advantageous effect of the present embodiment further more surely, it is preferable to set the lower limit value of Conditional Expression (8) to 0.60, and more preferable to 0.65.

The optical system OL according to the present embodiment preferably satisfies Conditional Expression (9) shown below.

$$0.5 < ( - fR ) / f < 3. \qquad ( 9 )$$

in the expression,
fR: focal length of the rear group GR, and
f: overall focal length of the optical system OL at focusing on an infinite distance object.

Conditional Expression (9) defines the ratio of the focal length of the rear group GR to the overall focal length of the optical system OL at focusing on an infinite distance object. By satisfying Conditional Expression (9), it is possible to excellently correct field curvature, lateral chromatic aberration, distortion, and the like of the optical system OL. Meanwhile, it is possible to secure the advantageous effect of the present embodiment more surely by setting the upper limit value of Conditional Expression (9) to 2.90. Further, in order to secure the advantageous effect of the present embodiment further more surely, it is preferable to set the upper limit value of Conditional Expression (9) to 2.75, 2.60, 2.50, and more preferable to 2.40. Meanwhile, it is possible to secure the advantageous effect of the present embodiment more surely by setting the lower limit value of Conditional Expression (9) to 0.60. Further, in order to secure the advantageous effect of the present embodiment further more surely, it is preferable to set the lower limit value of Conditional Expression (9) to 0.75, 0.90, and more preferable to 1.00.

The optical system OL according to the present embodiment preferably satisfies Conditional Expression (10) shown below.

$$1. < ( - fR ) / fM < 3. \qquad ( 10 )$$

in the expression,
fR: focal length of the rear group GR, and
fM: focal length of the intermediate group GM at focusing on an infinite distance object.

Conditional Expression (10) defines the ratio of the focal length of the rear group GR to the focal length of the intermediate group GM at focusing on an infinite distance object. By satisfying Conditional Expression (10), it is possible to excellently reduce aberration variation at focusing. When the upper limit value of Conditional Expression (10) is exceeded, the refractive power of the rear group GR is weak for that of the intermediate group GM in the optical system OL and it is possible to excellently correct axial chromatic aberration, lateral chromatic aberration, and the like, but aberration variation at focusing is large, and hence such a configuration is not preferable. Meanwhile, it is possible to secure the advantageous effect of the present embodiment more surely by setting the upper limit value of Conditional Expression (10) to 2.90. Further, in order to secure the advantageous effect of the present embodiment further more surely, it is preferable to set the upper limit value of Conditional Expression (10) to 2.80, 2.70, and more preferable to 2.60. Moreover, when the lower limit value of Conditional Expression (10) is exceeded, the refractive power of the rear group GR is strong for that of the intermediate group GM in the optical system OL and it is possible to excellently reduce aberration variation at focusing, but it is difficult to correct axial chromatic aberration, lateral chromatic aberration, and the like, and hence such a configuration is not preferable. Meanwhile, it is possible to secure the advantageous effect of the present embodiment more surely by setting the lower limit value of Conditional Expression (10) to 1.10. Further, in order to secure the advantageous effect of the present embodiment further more surely, it is preferable to set the lower limit value of Conditional Expression (10) to 1.20, 1.30, 1.40, and more preferable to 1.45.

The optical system OL according to the present embodiment preferably satisfies Conditional Expression (11) shown below.

$$0.1 < BF / TL < 0.3 \qquad ( 11 )$$

in the expression,
BF: back focus (air-conversion length) of the optical system OL at focusing on an infinite distance object, and
TL: optical total length (air-conversion length) of the optical system OL at focusing on an infinite distance object.

Conditional Expression (11) defines the ratio of the back focus to the optical total length of the optical system OL at focusing on an infinite distance object. By satisfying Conditional Expression (11), it is possible to excellently correct a variety of aberrations of the optical system OL, such as spherical aberration and field curvature, while achieving weight and size reduction thereof. Meanwhile, it is possible to secure the advantageous effect of the present embodiment more surely by setting the upper limit value of Conditional Expression (11) to 0.28. Further, in order to secure the advantageous effect of the present embodiment further more surely, it is preferable to set the upper limit value of Conditional Expression (11) to 0.25. Meanwhile, it is possible to secure the advantageous effect of the present embodiment more surely by setting the lower limit value of Conditional Expression (11) to 0.11. Further, in order to secure the advantageous effect of the present embodiment further more surely, it is preferable to set the lower limit value of Conditional Expression (11) to 0.12, and more preferable to 0.13.

The optical system OL according to the present embodiment preferably satisfies Conditional Expression (12) shown below.

$$- 0.4 < f / fL 1 < 0.3 \qquad ( 12 )$$

in the expression,
f: overall focal length of the optical system OL at focusing on an infinite distance object, and
fL1: focal length of a lens component L1 disposed closest to the object side.

Conditional Expression (12) defines the ratio of the overall focal length of the optical system OL at focusing on an infinite distance object to the focal length of the lens component L1 disposed closest to the object side in the optical system OL. By satisfying Conditional Expression (12), it is possible to excellently correct a variety of aberrations such as spherical aberration, coma aberration, field curvature, and astigmatism of the optical system OL and excellently reduce aberration variation at focusing. Meanwhile, it is possible to secure the advantageous effect of the present embodiment more surely by setting the upper limit value of Conditional Expression (12) to 0.25. Further, in order to secure the advantageous effect of the present embodiment further more surely, it is preferable to set the upper limit value of Conditional Expression (12) to 0.20, 0.15, and more preferable to 0.12. Meanwhile, it is possible to secure the advantageous effect of the present embodiment more surely by setting the lower limit value of Conditional Expression (12) to −0.35. Further, in order to secure the advantageous effect of the present embodiment further more surely, it is preferable to set the lower limit value of Conditional Expression (12) to −0.30, −0.25, and more preferable to −0.20.

Note that conditions and configurations described above each achieve an above-described effect, and not all configurations and conditions necessarily need to be satisfied but the above-described effect can be obtained with either conditions or configurations or with either combination of conditions or configurations.

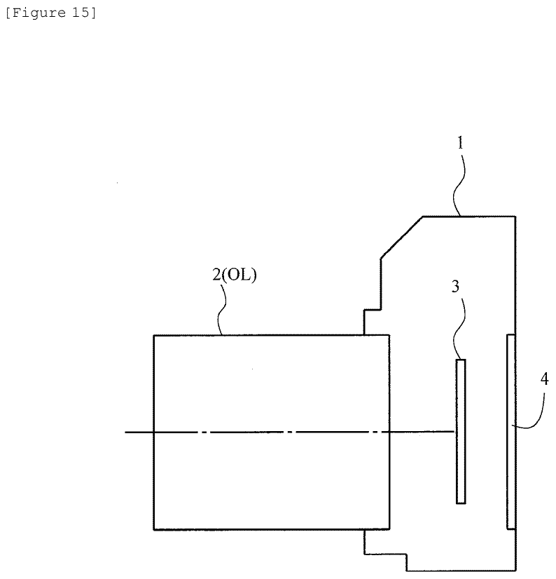

Subsequently, a camera that is an optical apparatus including the optical system OL according to the present embodiment will be described below with reference to FIG. 15. This camera 1 is what is called a mirrorless interchangeable lens camera including the optical system OL according to the present embodiment as an image pickup lens 2. In the camera 1, light from a non-shown object (subject) is condensed through the image pickup lens 2 and forms a subject image on the image surface of an image unit 3 through a non-shown optical low pass filter (OLPF). Then, the subject image is photoelectrically converted by a photoelectric conversion element (image sensor) provided in the image unit 3 and an image of the subject is generated. The image is displayed on an electronic view finder (EVF) 4 provided in the camera 1. Accordingly, a photographer can observe the subject through the EVF 4.

When a non-shown release button is pressed by the photographer, the image photoelectrically converted by the image unit 3 is stored in a non-shown memory. In this manner, the photographer can perform image capturing of the subject with the camera 1. Meanwhile, although the example of a mirrorless camera is described in the present embodiment, it is possible to achieve the same effects as those of the camera 1 described above when the optical system OL according to the present embodiment is mounted on a single-lens reflex camera that includes a quick return mirror in a camera body and with which a subject is observed through a finder optical system.

The contents described below are employable as appropriate to the extent that the optical performance is not compromised.

In the present embodiment, the optical system OL having a three-group configuration or a four-group configuration is shown as described later, and such configurations, conditions, and the like are also applicable to any other group configuration such as a five-group configuration or a six-group configuration. Further, the optical system OL may instead have a configuration in which a lens or a lens group closest to the object side is added or a configuration in which a lens or a lens group closest to the image plane side is added. Specifically, such a configuration is a configuration in which a lens group having a position fixed relative to the image plane at focusing is added closest to the image plane side in the optical system OL. A lens group means a part including at least one lens and separated by an air space that changes at focusing as long as no boundary is designated. A lens component means a single lens or a cemented lens obtained by cementing a plurality of lenses.

A focusing group may be a single lens group, a plurality of lens groups, or a partial lens group moved in the optical axis direction to focus on from an infinite distance object to a close distance object. In this case, the focusing group can also be used to perform autofocusing and is suitably driven by a motor for autofocusing (such as an ultrasonic wave motor). In particular, the focusing group is preferably a second lens group G2 in the case of a three-group configuration or at least one of the second lens group G2 and a third lens group G3 in the case of a four-group configuration, and any other lens preferably has a position fixed relative to the image plane at focusing.

An anti-vibration group may be a lens group or a partial lens group moved with a displacement component in the direction perpendicular to the optical axis or rotated (swung) in an in-plane direction containing the optical axis to correct an image blur caused by a camera shake. In particular, the anti-vibration group is preferably at least part of the second lens group G2 in the case of a three-group configuration or at least part of the second lens group G2 or the third lens group G3 in the case of a four-group configuration.

A lens surface may be so formed as to be a spherical surface, a flat surface, or an aspheric surface. In the case where a lens surface is a spherical or flat surface, the lens is readily processed, assembled, and adjusted, whereby degradation in the optical performance due to errors in the lens processing, assembly, and adjustment is preferably avoided. Further, even when an image plane is shifted, the amount of degradation in drawing performance is preferably small. In the case where the lens surface is an aspheric surface, the aspheric surface may be any of a ground aspheric surface, a glass molded aspheric surface that is a glass surface so molded in a die as to have an aspheric shape, and a composite aspheric surface that is a glass surface on which aspherically shaped resin is formed. The lens surface may instead be a diffractive surface, or the lenses may be any of a distributed index lens (GRIN lens) or a plastic lens.

The aperture stop S is preferably disposed in the intermediate group GM. No member as an aperture stop may be provided, and the frame of a lens may serve as the aperture stop.

Further, each lens surface may be provided with an antireflection coating having high transmittance over a wide wavelength range to achieve good optical performance that reduces flare and ghost and achieves high contrast.

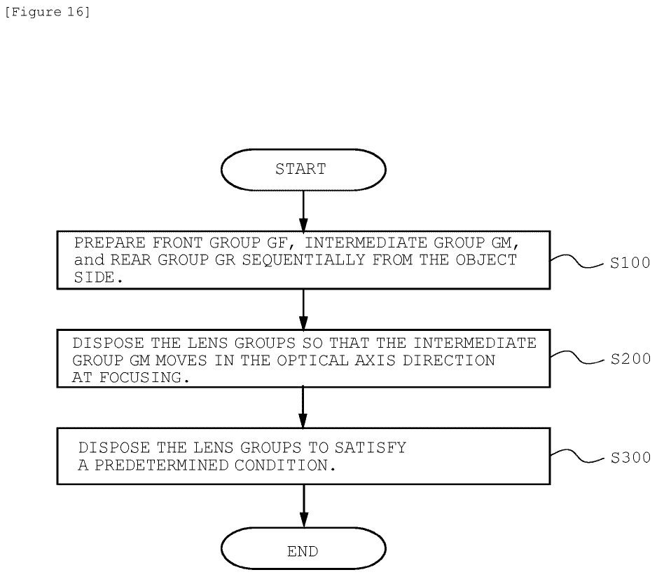

A method for manufacturing the optical system OL according to the present embodiment will be schematically described below with reference to FIG. 16. First, the front group GF, the intermediate group GM, and the rear group GR are prepared sequentially from the object side (step S100). Subsequently, the lens groups are disposed so that the intermediate group GM moves in the optical axis direction at focusing (step S200). Then, the lens groups are disposed so that a predetermined condition (for example, Conditional Expression (1) described above in the first embodiment, or Conditional Expressions (2) and (3) described above in the second embodiment) is satisfied (step S300).

In this manner, an optical system having an image pickup magnification of 0.5× or more and capable of ensuring favorable optical performance while achieving weight and size reduction, an optical apparatus, and a method for manufacturing the optical system can be provided.

### EXAMPLES

Examples will be described below with reference to the accompanying drawings. Note that FIGS. 1, 3, 5, 7, 9, 11, and 13 are cross-sectional views showing the configurations of optical systems OL (OL1 to OL7) according to the examples and the refractive power distribution thereof. In the lower parts of the cross-sectional views of the optical systems OL1 to OL7, arrows show the moving directions of the lens groups on the optical axis at focusing on from an infinite distance object (o) to a close distance object.

In the second to seventh examples, each aspheric surface is expressed by Expression (a) below, where y represents the height in a direction perpendicular to the optical axis, S(y) represents the distance (sag amount) on the optical axis from a tangent plane at the apex of the aspheric surface at the height y to the aspheric surface, r represents the radius of curvature (paraxial radius of curvature) of a reference spherical surface, K represents the conic constant, and An represents the n-th aspheric surface coefficient. Note that, in the examples below, “e-n” represents “×10⁻ⁿ”.

$$S ( y ) = ( {y}^{2} / r ) / ( 1 + {( 1 - {Kxy}^{2} / {r}^{2} )}^{1 / 2} ) + {A 4 xy}^{4} + {A 6 xy}^{6} + {A 8 xy}^{8} + {A 10 xy}^{10} + {A 12 xy}^{12} + {A 14 xy}^{14} … \qquad ( a )$$

Note that, in the examples, the second aspheric surface coefficient A2 is zero. In tables of the examples, the symbol “*” is attached on the right side of the surface number of an aspheric surface.

### First Example

FIG. 1 is a diagram showing the configuration of the optical system OL1 according to a first example. The optical system OL1 includes, sequentially from an object side, a front group GF including a first lens group G1 having positive refractive power, an intermediate group GM including a second lens group G2 having positive refractive power and a third lens group G3 having positive refractive power and having positive refractive power as a whole, and a rear group GR including a fourth lens group G4 having negative refractive power.

The first lens group G1 includes a positive lens L11 (L1) in a meniscus shape having a convex surface facing the object side. The second lens group G2 includes, sequentially from the object side, a negative lens L21 in a meniscus shape having a convex surface facing the object side, and a positive lens L22 in a meniscus shape having a convex surface facing the object side. The third lens group G3 includes, sequentially from the object side, a biconcave negative lens L31, a positive lens L32 in a meniscus shape having a concave surface facing the object side, and a biconvex positive lens L33. The fourth lens group G4 includes, sequentially from the object side, a biconcave negative lens L41, a positive lens L42 in a meniscus shape having a concave surface facing the object side, and a biconcave negative lens L43 (LL).

In the optical system OL1, an aperture stop S is disposed between the second lens group G2 and the third lens group G3 in the intermediate group GM. In addition, a filter group FL is disposed between the fourth lens group G4 and an image plane I.

In the optical system OL1, the second lens group G2 and the third lens group G3 as the intermediate group GM move to the object side on the optical axis at focusing on from an infinite distance object to a close distance object. The aperture stop S moves together with the second lens group G2 at focusing.

Table 1 below shows values of specifications of the optical system OL1. In Table 1, the following specifications shown as overall specifications are defined as follows: f represents the overall focal length; Fno represents the F number; ω represents the half angle of view [°]; Y represents the maximum image height; TL represents the optical total length; and Bf represents values of the back focus at focusing on an infinite distance object. The back focus Bf represents the distance on the optical axis from the lens surface (thirty-ninth surface) closest to the image plane side to the image plane I. The optical total length TL represents a length obtained by adding the back focus to the distance on the optical axis from the lens surface (first surface) closest to the object side to the lens surface (thirty-ninth surface) closest to the image plane side. In lens data, a first field m shows the sequence of lens surfaces (surface numbers) counted from the object side in a direction in which a ray travels, a second field r shows the radius of curvature of each lens surface, a third field d shows the distance (inter-surface distance) on the optical axis from each optical surface to the next optical surface, and a fourth field nd and a fifth field νd show the refractive index and the Abbe number at the d line (λ=587.6 nm). A radius of curvature ∞ represents a flat surface, and the refractive index of air, which is 1.00000, is omitted. The lens group focal length shows the surface number of the first surface and the focal length of each lens group.

The unit of each of the focal length f, the radius of curvature r, the inter-surface distance d, and other lengths shown in all the variety of specifications below is typically “mm”, but not limited to this, because an optical system provides the same optical performance even when the optical system is proportionally enlarged or reduced. The above description of symbols and specification tables applies to subsequent examples as well.

TABLE 1
First example
[Overall specifications]

| | | |
|---|---|---|
| f | = | 39.532 |
| Fno | = | 2.82 |
| ω[°] | = | 19.04 |
| Y | = | 14.200 |
| TL | | 91.000 |
| TL (air-conversion length) | = | 90.455 |
| BF | = | 13.600 |
| BF (air-conversion length) | = | 13.055 |

[Lens data]

| m | r | d | nd | vd |
|---|---|---|---|---|
| Object plane | ∞ | | | |
| 1 | 100.0000 | 2.5000 | 1.48749 | 70.32 |
| 2 | 200.0000 | d1 | | |
| 3 | 17.1714 | 1.2000 | 1.62299 | 58.12 |
| 4 | 13.6956 | 8.9068 | | |
| 5 | 22.4494 | 4.1000 | 1.60311 | 60.69 |
| 6 | 152.7709 | 5.5226 | | |
| 7 | ∞ | d2 | Aperture stop S | |
| 8 | −33.8144 | 1.0000 | 1.84666 | 23.80 |
| 9 | 40.4635 | 0.9000 | | |
| 10 | −127.9705 | 2.5000 | 1.65160 | 58.57 |
| 11 | −21.7834 | 0.1000 | | |
| 12 | 32.3448 | 4.1000 | 1.80610 | 40.98 |
| 13 | −52.6084 | d3 | | |
| 14 | −135.7811 | 1.0000 | 1.48749 | 70.32 |
| 15 | 34.0082 | 1.5713 | | |
| 16 | −593.0949 | 3.4000 | 1.77250 | 49.62 |
| 17 | −27.6401 | 6.2884 | | |
| 18 | −16.5865 | 1.2000 | 1.51680 | 64.13 |
| 19 | 214.0528 | 10.5000 | | |
| 20 | ∞ | 1.6000 | 1.51680 | 64.13 |
| 21 | ∞ | 1.5000 | | |
| Image plane | ∞ | | | |

[Focal length of lens groups]

| Lens group | First surface | Focal length |
|---|---|---|
| Front group GF (First lens group G1) | 1 | 406.931 |
| Intermediate group GM | 3 | 27.854 |
| Second lens group G2 | 3 | 61.926 |
| Third lens group G3 | 8 | 36.238 |
| Rear group GR (Fourth lens group G4) | 14 | −43.251 |

In the optical system OL1, an on-axis air space d1 between the first lens group G1 and the second lens group G2, an on-axis air space d2 between the second lens group G2 and the third lens group G3, and an on-axis air space d3 between the third lens group G3 and the fourth lens group G4 change at focusing. Table 2 below shows variable spaces at focusing on an infinite distance object and at focusing on a close distance object. Note that f represents the focal length, and β represents the image pickup magnification. This description applies to subsequent examples as well.

TABLE 2
[Variable space data]

| | Infinite distance | Close distance |
|---|---|---|
| | object | object |
| f | 39.532 | — |
| β | — | −1.00 |
| d1 | 28.0111 | 1.5000 |
| d2 | 3.5000 | 8.4471 |
| d3 | 1.6000 | 23.1639 |

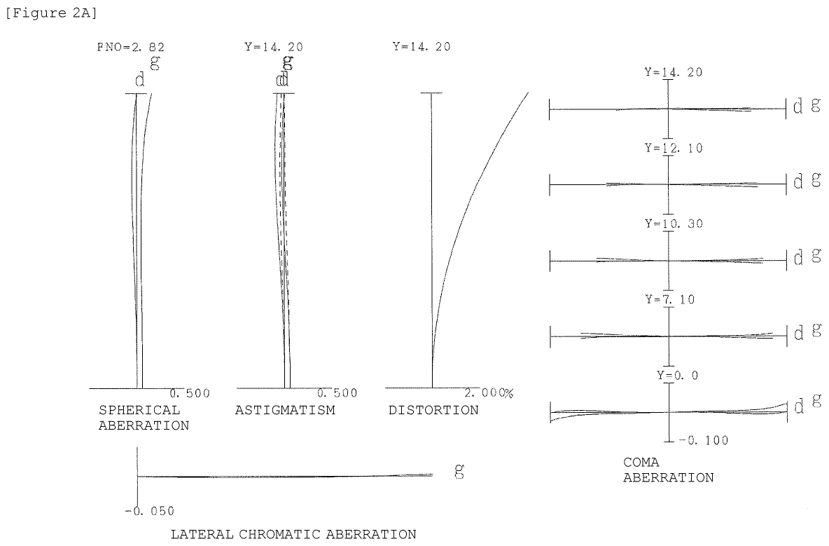

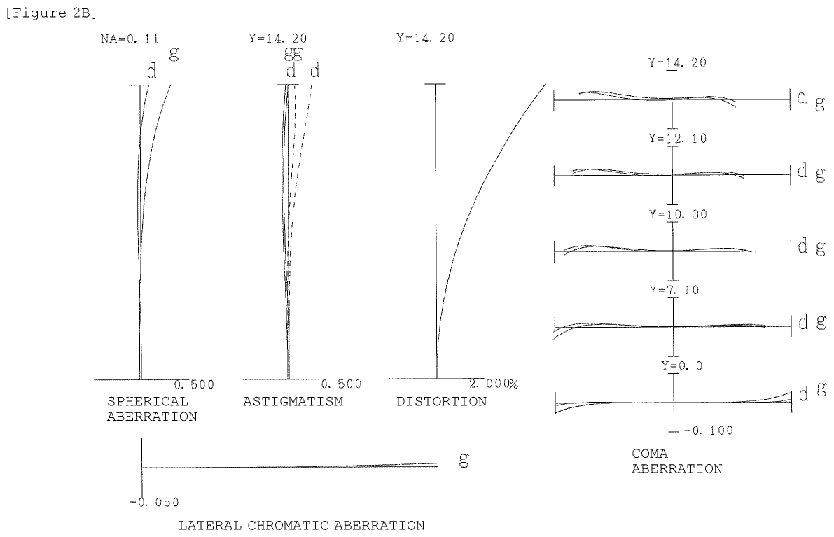

FIG. 2 shows a spherical aberration diagram, an astigmatism diagram, a distortion diagram, a lateral chromatic aberration diagram, and a coma aberration diagram of the optical system OL1 at focusing on an infinite distance object and at focusing on a close distance object. In each aberration diagram, FNo represents the F number, NA represents the aperture number, and Y represents the image height. Note that the spherical aberration diagram shows the value of the F number or the aperture number corresponding to the maximum diameter, the astigmatism diagram and the distortion diagram shows the maximum value of the image height, and the coma aberration diagram shows the value of each image height. In addition, d represents the d-line (λ=587.6 nm), and g represents the g-line (λ=435.8 nm). In the astigmatism diagram, the solid line represents the sagittal image plane, and the dashed line represents the meridional image plane. Further, in the aberration diagrams in the following examples, the same reference characters as those in the present example are used. The aberration diagrams show that the optical system OL1 allows favorable correction of the variety of aberrations and has excellent imaging performance.

### Second Example

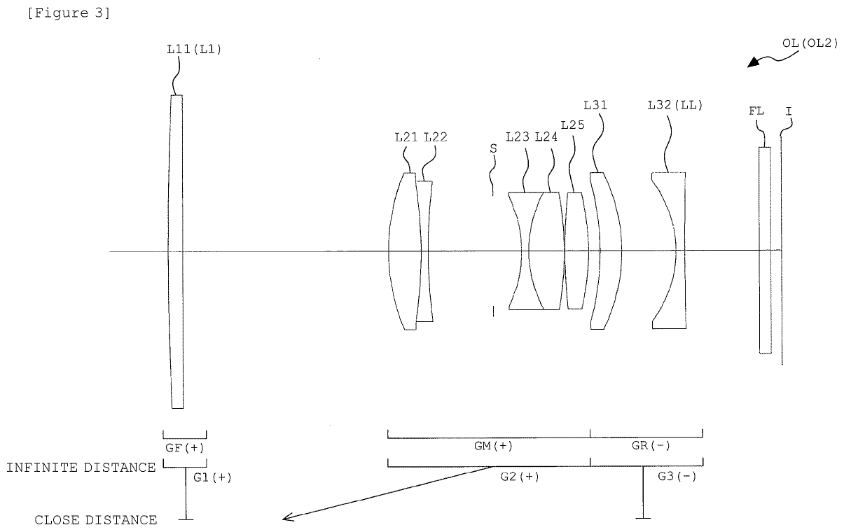

FIG. 3 is a diagram showing the configuration of the optical system OL2 according to a second example. The optical system OL2 includes, sequentially from the object side, a front group GF including a first lens group G1 having positive refractive power, an intermediate group GM including a second lens group G2 having positive refractive power, and a rear group GR including a third lens group G3 having negative refractive power.

The first lens group G1 includes a plano-convex positive lens L11 (L1) having a convex surface facing the object side. The second lens group G2 includes, sequentially from the object side, a cemented positive lens formed by cementing a biconvex positive lens L21 and a biconcave negative lens L22, a cemented negative lens formed by cementing a biconcave negative lens L23 and a biconvex positive lens L24, and a biconvex positive lens L25 formed with an aspheric lens surface on the image plane side. The third lens group G3 includes, sequentially from the object side, a positive lens L31 in a meniscus shape having a concave surface facing the object side, and a biconcave negative lens L32 (LL).

In the optical system OL2, an aperture stop S is disposed between the negative lens L22 and the negative lens L23 in the second lens group G2 as the intermediate group GM. In addition, a filter group FL is disposed between the third lens group G3 and an image plane I.

In the optical system OL2, the second lens group G2 as the intermediate group GM moves to the object side on the optical axis at focusing on from an infinite distance object to a close distance object. The aperture stop S moves together with the second lens group G2 at focusing.

Table 3 below shows values of specifications of the optical system OL2.

TABLE 3
Second example
[Overall specifications]

| | | |
|---|---|---|
| f | = | 41.335 |
| Fno | = | 2.07 |
| ω[°] | = | 18.39 |
| Y | = | 14.200 |
| TL | = | 85.800 |
| TL (air-conversion length) | = | 85.255 |
| BF | = | 13.600 |
| BF (air-conversion length) | = | 13.055 |

[Lens data]

| m | r | d | nd | vd |
|---|---|---|---|---|
| Object plane | ∞ | | | |
| 1 | 500.0000 | 2.0000 | 1.48749 | 70.32 |
| 2 | ∞ | d1 | | |
| 3 | 28.1947 | 4.6000 | 1.71999 | 50.27 |
| 4 | −61.1236 | 1.0000 | 1.80100 | 34.92 |
| 5 | 74.1433 | 9.0000 | | |
| 6 | ∞ | 4.0000 | Aperture stop S | |
| 7 | −17.6671 | 1.0000 | 1.62588 | 35.72 |
| 8 | 17.0726 | 5.0000 | 1.80400 | 46.60 |
| 9 | −46.4184 | 0.1000 | | |
| 10 | 79.5479 | 3.3000 | 1.62263 | 58.16 |
| 11* | −30.3176 | d2 | | |
| 12 | −36.8461 | 3.0000 | 1.78590 | 44.17 |
| 13 | −25.0125 | 7.6000 | | |
| 14 | −16.0825 | 1.2000 | 1.48749 | 70.32 |
| 15 | 401.0302 | 10.5000 | | |
| 16 | ∞ | 1.6000 | 1.51680 | 64.13 |
| 17 | ∞ | 1.5000 | | |
| Image plane | ∞ | | | |

[Focal length of lens groups]

| Lens group | First surface | Focal length |
|---|---|---|
| Front group GF (First lens group G1) | 1 | 1025.662 |
| Intermediate group GM | 3 | 33.624 |
| (Second lens group G2) | | |
| Rear group GR (Third lens group G3) | 12 | −53.277 |

In the optical system OL2, the eleventh surface is formed in an aspheric shape. Table 4 below shows aspheric surface data, in other words, the values of the conic constant K and the aspheric surface constants A4 to A14.

TABLE 4
[Aspheric surface data]
Eleventh surface
K = 1.00000

| | | |
|---|---|---|
| A4 = 3.71185E−05 | A6 = −6.46471E−07 | A8 = 3.01332E−08 |
| A10 = −7.16019E−10 | A12 = 8.76060E−12 | A14 = 4.29930E−14 |

In the optical system OL2, an on-axis air space d1 between the first lens group G1 and the second lens group G2, and an on-axis air space d2 between the second lens group G2 and the third lens group G3 change at focusing. Table 5 below shows variable spaces at focusing on an infinite distance object and at focusing on a close distance object.

TABLE 5
[Variable space data]

| | Infinite distance object | Close distance object |
|---|---|---|
| f | 41.335 | — |
| β | — | −1.00 |
| d1 | 28.8000 | 1.3000 |
| d2 | 1.6000 | 29.1000 |

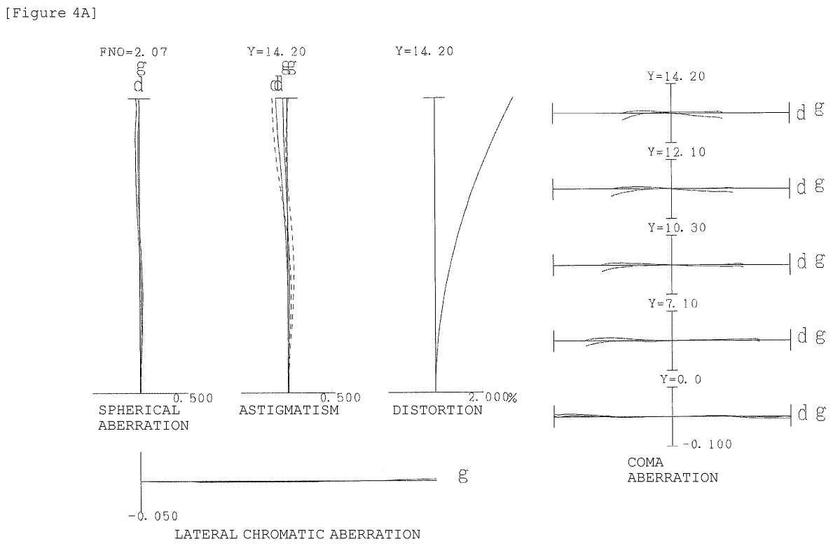

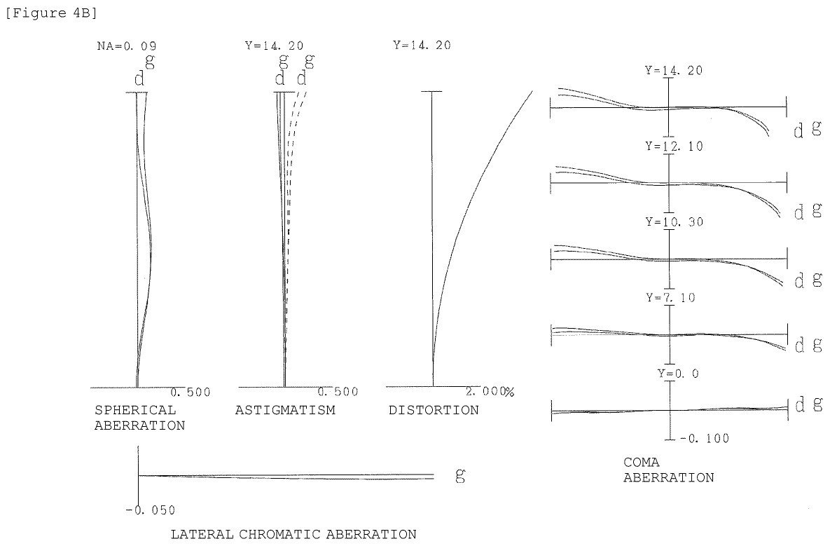

FIG. 4 shows a spherical aberration diagram, an astigmatism diagram, a distortion diagram, a lateral chromatic aberration diagram, and a coma aberration diagram of the optical system OL2 at focusing on an infinite distance object and at focusing on a close distance object. The aberration diagrams show that the optical system OL2 allows favorable correction of the variety of aberrations and has excellent imaging performance.

### Third Example

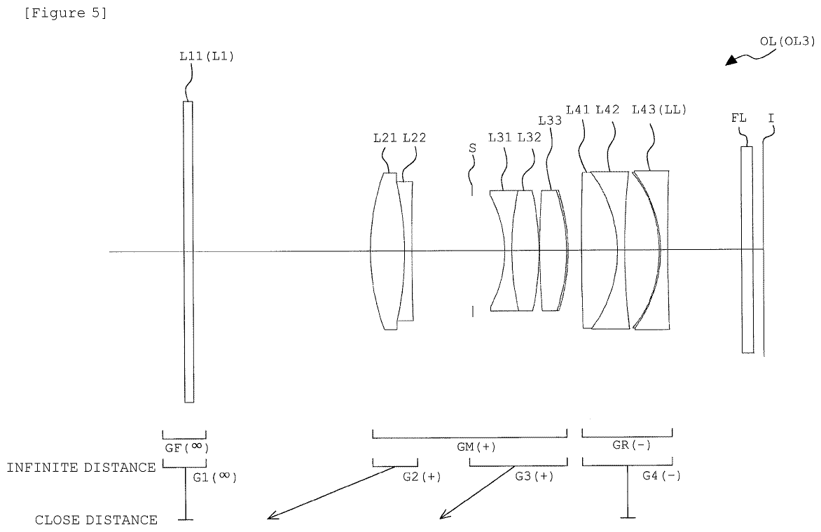

FIG. 5 is a diagram showing the configuration of the optical system OL3 according to a third example. The optical system OL3 includes, sequentially from the object side, a front group GF including a first lens group G1, an intermediate group GM including a second lens group G2 having positive refractive power and a third lens group G3 having positive refractive power and having positive refractive power as a whole, and a rear group GR including a fourth lens group G4 having negative refractive power.

The first lens group G1 includes a parallel flat plate L11 (L1). The second lens group G2 includes a cemented positive lens formed by cementing a biconvex positive lens L21 and a biconcave negative lens L22 sequentially from the object side. The third lens group G3 includes, sequentially from the object side, a cemented negative lens formed by cementing a biconcave negative lens L31 and a biconvex positive lens L32, and a biconvex positive lens L33 formed with an aspheric lens surface on the image plane side. Note that the positive lens L33 is a composite lens having an aspheric surface formed of a resin layer provided on the image-plane-side surface of a glass lens body. The fourth lens group G4 includes, sequentially from the object side, a cemented positive lens formed by cementing a biconvex positive lens L41 and a biconcave negative lens L42, and a biconcave negative lens L43 (LL) formed with an aspheric lens surface on the object side. Note that the negative lens L43 is a composite lens having an aspheric surface formed of a resin layer provided on the image-plane-side surface of a glass lens body.

In the optical system OL3, an aperture stop S is disposed between the second lens group G2 and the third lens group G3 in the intermediate group GM. In addition, a filter group FL is disposed between the fourth lens group G4 and an image plane I.

In the optical system OL3, the second lens group G2 and the third lens group G3 as the intermediate group GM move to the object side on the optical axis at focusing on from an infinite distance object to a close distance object. The aperture stop S moves together with the third lens group G3 at focusing.

Table 6 below shows values of specifications of the optical system OL3.

TABLE 6
Third example
[Overall specifications]

| | | |
|---|---|---|
| f | = | 35.500 |
| Fno | = | 1.86 |
| ω[°] | = | 21.09 |
| Y | = | 14.200 |
| TL | = | 81.000 |
| TL (air-conversion length) | = | 80.455 |
| BF | = | 13.400 |
| BF (air-conversion length) | = | 12.855 |

[Lens data]

| m | r | d | nd | vd |
|---|---|---|---|---|
| Object plane | ∞ | | | |
| 1 | ∞ | 1.2000 | 1.48749 | 70.32 |
| 2 | ∞ | d1 | | |
| 3 | 32.3113 | 4.8000 | 1.70000 | 48.10 |
| 4 | −44.7976 | 1.0000 | 1.83400 | 37.18 |
| 5 | 292.5746 | d2 | | |
| 6 | ∞ | 4.5000 | Aperture stop S | |
| 7 | −16.1414 | 1.0000 | 1.71736 | 29.57 |
| 8 | 40.2209 | 3.8000 | 1.80400 | 46.60 |
| 9 | −38.4171 | 0.1000 | | |
| 10 | 110.7728 | 3.8000 | 1.80400 | 46.60 |
| 11 | −25.6333 | 0.2000 | 1.56093 | 36.64 |
| 12* | −25.6333 | d3 | | |
| 13 | 355.6821 | 5.0000 | 1.88300 | 40.66 |
| 14 | −18.2588 | 1.0000 | 1.58144 | 40.98 |
| 15 | 95.1472 | 4.8661 | | |
| 16* | −20.1725 | 0.2000 | 1.56093 | 36.64 |
| 17 | −18.0890 | 1.0000 | 1.51742 | 52.20 |
| 18 | 337.3157 | 10.3000 | | |
| 19 | ∞ | 1.6000 | 1.51680 | 64.13 |
| 20 | ∞ | 1.5000 | | |
| Image plane | ∞ | | | |

[Focal length of lens groups]

| Lens group | First surface | Focal length |
|---|---|---|
| Front group GF (First lens group G1) | 1 | ∞ |
| Intermediate group GM | 3 | 32.878 |
| Second lens group G2 | 3 | 61.694 |
| Third lens group G3 | 7 | 40.089 |
| Rear group GR (Fourth lens group G4) | 13 | −84.292 |

In the optical system OL3, the twelfth surface and the sixteenth surface are each formed in an aspheric shape. Table 7 below shows aspheric surface data, in other words, the values of the conic constant K and the aspheric surface constants A4 to A14.

TABLE 7
[Aspheric surface data]

Twelfth surface
K = 1.00000

| | | |
|---|---|---|
| A4 = 2.46184E−05 | A6 = −2.41773E−07 | A8 = 1.11585E−08 |
| A10 = −2.69002E−10 | A12 = 3.24180E−12 | A14 = 1.52330E−14 |

Sixteenth surface

| | | |
|---|---|---|
| K = 1.00000 | | |
| A4 = −3.88298E−05 | A6 = 1.22826E−07 | A8 = −2.32494E−09 |
| A10 = 9.49732E−12 | A12 = 0.00000E+00 | A14 = 0.00000E+00 |

In the optical system OL3, an on-axis air space d1 between the first lens group G1 and the second lens group G2, an on-axis air space d2 between the second lens group G2 and the third lens group G3, and an on-axis air space d3 between the third lens group G3 and the fourth lens group G4 change at focusing. Table 8 below shows variable spaces at focusing on an infinite distance object and at focusing on a close distance object.

TABLE 8
[Variable space data]

| | Infinite distance object | Close distance object |
|---|---|---|
| f | 35.500 | — |
| β | — | −0.70 |
| d1 | 24.8000 | 2.6000 |
| d2 | 8.5000 | 9.3828 |
| d3 | 1.8340 | 23.1512 |

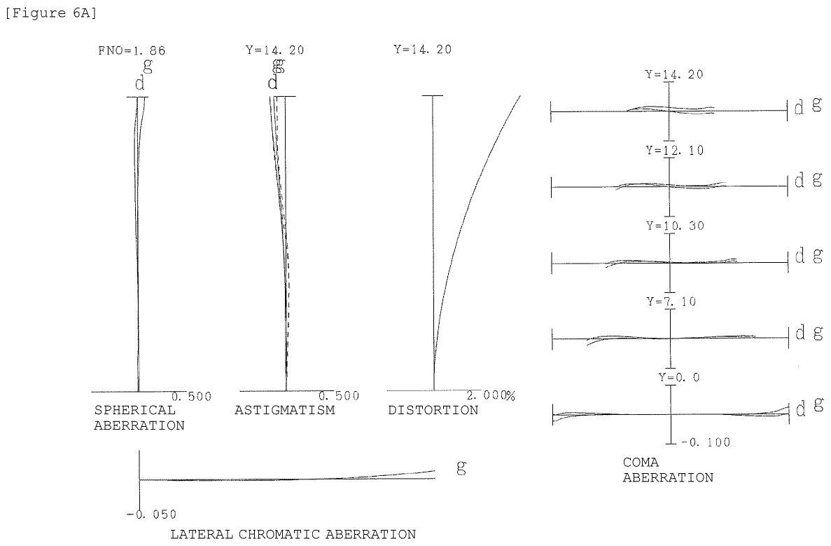

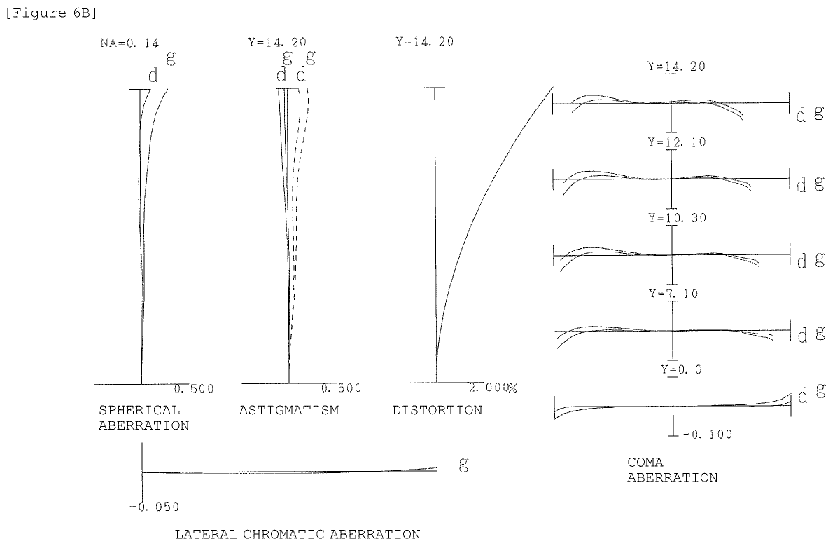

FIG. 6 shows a spherical aberration diagram, an astigmatism diagram, a distortion diagram, a lateral chromatic aberration diagram, and a coma aberration diagram of the optical system OL3 at focusing on an infinite distance object and at focusing on a close distance object. The aberration diagrams show that the optical system OL3 allows favorable correction of the variety of aberrations and has excellent imaging performance.

### Fourth Example

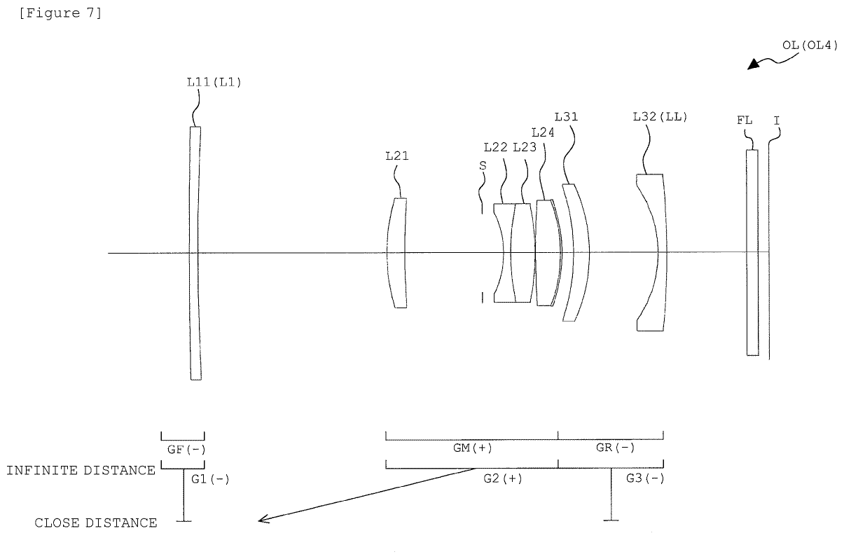

FIG. 7 is a diagram showing the configuration of the optical system OL4 according to a fourth example. The optical system OL4 includes, sequentially from the object side, a front group GF including a first lens group G1 having negative refractive power, an intermediate group GM including a second lens group G2 having positive refractive power, and a rear group GR including a third lens group G3 having negative refractive power.

The first lens group G1 includes a negative lens L11 in a meniscus shape having a convex surface facing the object side (L1). The second lens group G2 includes, sequentially from the object side, a positive lens L21 in a meniscus shape having a convex surface facing the object side, a cemented negative lens formed by cementing a biconcave negative lens L22 and a biconvex positive lens L23, and a biconvex positive lens L24 formed with an aspheric lens surface on the image plane side. Note that the positive lens L24 is a composite lens having an aspheric surface formed of a resin layer provided on the image-plane-side surface of a glass lens body. The third lens group G3 includes, sequentially from the object side, a positive lens L31 in a meniscus shape having a concave surface facing the object side, and a negative lens L32 (LL) in a meniscus shape having a concave surface facing the object side.

In the optical system OL4, an aperture stop S is disposed between the positive lens L21 and the negative lens L22 in the second lens group G2 as the intermediate group GM. In addition, a filter group FL is disposed between the third lens group G3 and an image plane I.

In the optical system OL4, the second lens group G2 as the intermediate group GM moves to the object side on the optical axis at focusing on from an infinite distance object to a close distance object. The aperture stop S moves together with the second lens group G2 at focusing.

Table 9 below shows values of specifications of the optical system OL4.

TABLE 9
Fourth example
[Overall specifications]

| | |
|---|---|
| f = | 38.000 |
| Fno = | 2.86 |
| ω[°] = | 20.18 |
| Y = | 14.200 |
| TL = | 81.000 |
| TL (air-conversion length) = | 80.455 |
| BF = | 14.300 |
| BF (air-conversion length) = | 13.755 |

[Lens data]

| m | r | d | nd | vd | |
|---|---|---|---|---|---|
| Object plane | ∞ | | | | |
| 1 | 1000.0000 | 1.2000 | 1.67270 | 32.19 | |
| 2 | 341.6032 | d1 | | | |
| 3 | 26.3938 | 2.5000 | 1.61800 | 63.34 | |
| 4 | 104.4847 | 10.8000 | | | |
| 5 | ∞ | 3.0000 | | | Aperture stop S |
| 6 | −12.9734 | 1.0000 | 1.71736 | 29.57 | |
| 7 | 35.4454 | 3.4000 | 1.80400 | 46.60 | |
| 8 | −33.7721 | 0.1000 | | | |
| 9 | 128.6034 | 3.5000 | 1.79500 | 45.31 | |
| 10 | −20.4927 | 0.2000 | 1.56093 | 36.64 | |
| 11* | −20.4927 | d2 | | | |
| 12 | −30.0289 | 2.2000 | 1.74950 | 35.25 | |
| 13 | −23.0492 | 9.5978 | | | |
| 14 | −16.3907 | 1.2000 | 1.60311 | 60.69 | |
| 15 | −110.6686 | 11.2000 | | | |
| 16 | ∞ | 1.6000 | 1.51680 | 64.13 | |
| 17 | ∞ | 1.5000 | | | |
| Image plane | ∞ | | | | |

[Focal length of lens groups]

| Lens group | First surface | Focal length |
|---|---|---|
| Front group GF (First lens group G1) | 1 | −771.847 |
| Intermediate group GM (Second lens group G2) | 3 | 30.796 |
| Rear group GR (Third lens group G3) | 12 | −47.477 |

In the optical system OL4, the eleventh surface is formed in an aspheric shape. Table 10 below shows aspheric surface data, in other words, the values of the conic constant K and the aspheric surface constants A4 to A14.

TABLE 10
[Aspheric surface data]
Eleventh surface
K = 1.00000

| | | |
|---|---|---|
| A4 = 3.47586E−05 | A6 = −1.66949E−07 | A8 = 5.09420E−09 |
| A10 = −4.45933E−11 | A12 = 0.00000E+00 | A14 = 0.00000E+00 |

In the optical system OL4, an on-axis air space d1 between the first lens group G1 and the second lens group G2, and an on-axis air space d2 between the second lens group G2 and the third lens group G3 change at focusing. Table 11 below shows variable spaces at focusing on an infinite distance object and at focusing on a close distance object.

TABLE 11
[Variable space data]

| | Infinite distance object | Close distance object |
|---|---|---|
| f | 38.000 | — |
| β | — | −1.00 |
| d1 | 26.4022 | 1.6000 |
| d2 | 1.6000 | 26.4022 |

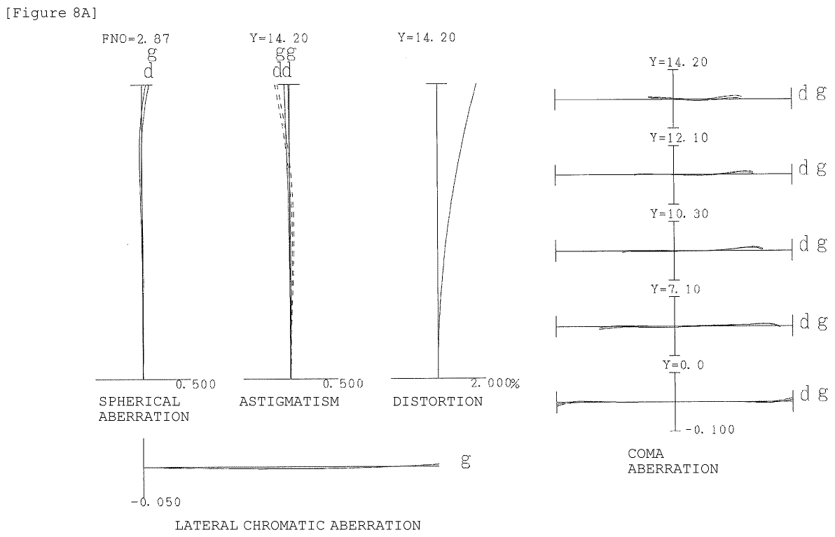

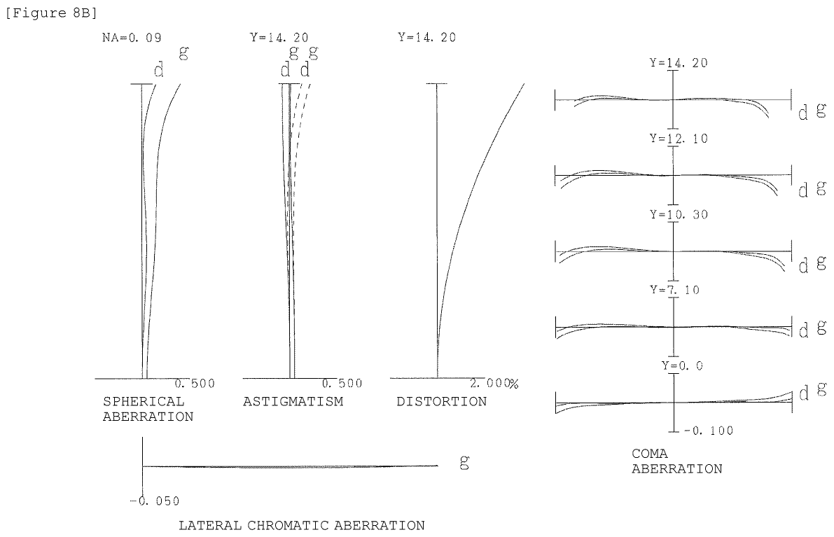

FIG. 8 shows a spherical aberration diagram, an astigmatism diagram, a distortion diagram, a lateral chromatic aberration diagram, and a coma aberration diagram of the optical system OL4 at focusing on an infinite distance object and at focusing on a close distance object. The aberration diagrams show that the optical system OL4 allows favorable correction of the variety of aberrations and has excellent imaging performance.

### Fifth Example

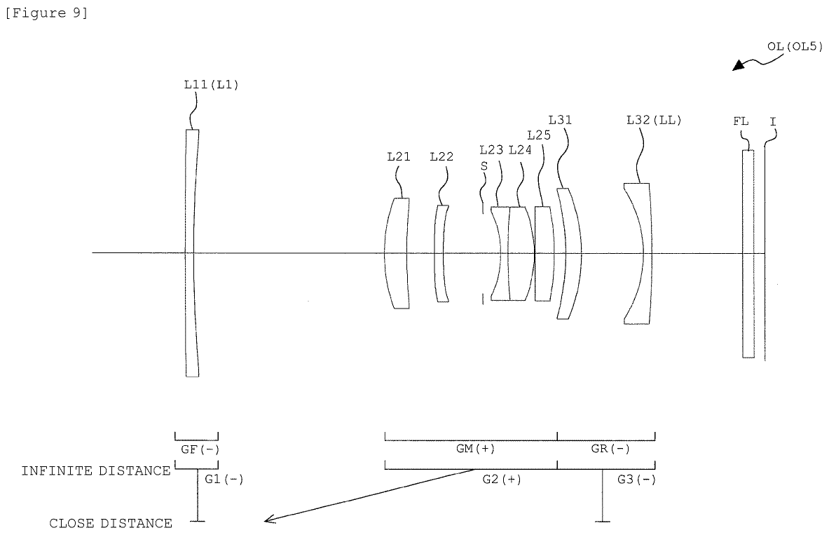

FIG. 9 is a diagram showing the configuration of the optical system OL5 according to a fifth example. The optical system OL5 includes, sequentially from the object side, a front group GF including a first lens group G1 having negative refractive power, an intermediate group GM including a second lens group G2 having positive refractive power, and a rear group GR including a third lens group G3 having negative refractive power.

The first lens group G1 includes a negative lens L11 in a meniscus shape having a convex surface facing the object side (L1). The second lens group G2 includes, sequentially from the object side, a positive lens L21 in a meniscus shape having a convex surface facing the object side, a negative lens L22 in a meniscus shape having a convex surface facing the object side and formed with aspheric lens surfaces on the object side and the image plane side, a cemented positive lens formed by cementing a biconcave negative lens L23 and a biconvex positive lens L24, and a positive lens L25 in a meniscus shape having a concave surface facing the object side. The third lens group G3 includes a positive lens L31 in a meniscus shape having a concave surface facing the object side, and a negative lens L32 (LL) in a meniscus shape having a concave surface facing the object side.

In the optical system OL5, an aperture stop S is disposed between the negative lens L22 and the negative lens L23 in the second lens group G2 as the intermediate group GM. In addition, a filter group FL is disposed between the third lens group G3 and an image plane I.

In the optical system OL5, the second lens group G2 as the intermediate group GM moves to the object side on the optical axis at focusing on from an infinite distance object to a close distance object. The aperture stop S moves together with the second lens group G2 at focusing.

Table 12 below shows values of specifications of the optical system OL5.

TABLE 12
Fifth example
[Overall specifications]

| | |
|---|---|
| f = | 38.257 |
| Fno = | 2.88 |
| ω[°] = | 20.21 |
| Y = | 14.200 |
| TL = | 81.000 |
| TL (air-conversion length) = | 80.455 |
| BF = | 15.800 |
| BF (air-conversion length) = | 15.255 |

[Lens data]

| m | r | d | nd | vd | |
|---|---|---|---|---|---|
| Object plane | ∞ | | | | |
| 1 | 1000.0000 | 1.2000 | 1.62299 | 58.12 | |
| 2 | 191.9205 | d1 | | | |
| 3 | 21.6636 | 3.2000 | 1.61800 | 63.34 | |
| 4 | 85.8643 | 3.9234 | | | |
| 5* | 5000.0000 | 1.2000 | 1.53504 | 55.71 | |
| 6* | 111.0085 | 5.4408 | | | |
| 7 | ∞ | 2.5000 | | | Aperture stop S |
| 8 | −13.9656 | 1.0000 | 1.75520 | 27.57 | |
| 9 | 70.8048 | 3.7000 | 1.80400 | 46.60 | |
| 10 | −16.9076 | 0.1000 | | | |
| 11 | −1132.4588 | 2.7000 | 1.80610 | 40.98 | |
| 12 | −34.9496 | d2 | | | |
| 13 | −33.0000 | 2.2000 | 1.69895 | 30.13 | |
| 14 | −23.5462 | 8.6359 | | | |
| 15 | −16.7498 | 1.2000 | 1.62299 | 58.12 | |
| 16 | −115.9839 | 12.7000 | | | |
| 17 | ∞ | 1.6000 | 1.51680 | 64.13 | |
| 18 | ∞ | 1.5000 | | | |
| Image plane | ∞ | | | | |

[Focal length of lens groups]

| Lens group | First surface | Focal length |
|---|---|---|
| Front group GF (First lens group G1) | 1 | −381.447 |
| Intermediate group GM (Second lens group G2) | 3 | 30.882 |
| Rear group GR (Third lens group G3) | 13 | −48.278 |

In the optical system OL5, the fifth surface and the sixth surface are each formed in an aspheric shape. Table 13 below shows aspheric surface data, in other words, the values of the conic constant K and the aspheric surface constants A4 to A14.

TABLE 13
[Aspheric surface data]
Fifth surface
K = 1.00000

| | | |
|---|---|---|
| A4 = 2.14608E−04 | A6 = −6.37110E−07 | A8 = 4.09234E−09 |
| A10 = 0.00000E+00 | A12 = 0.00000E+00 | A14 = 0.00000E+00 |

Sixth surface
K = 1.00000

| | | |
|---|---|---|
| A4 = 2.71565E−04 | A6 = −6.66060E−07 | A8 = 1.26067E−08 |
| A10 = 0.00000E+00 | A12 = 0.00000E+00 | A14 = 0.00000E+00 |

In the optical system OL5, an on-axis air space d1 between the first lens group G1 and the second lens group G2, and an on-axis air space d2 between the second lens group G2 and the third lens group G3 change at focusing. Table 14 below shows variable spaces at focusing on an infinite distance object and at focusing on a close distance object.

TABLE 14
[Variable space data]

| | Infinite distance object | Close distance object |
|---|---|---|
| f | 38.257 | — |
| β | — | −1.00 |
| d1 | 26.6000 | 1.6000 |
| d2 | 1.6000 | 26.6000 |

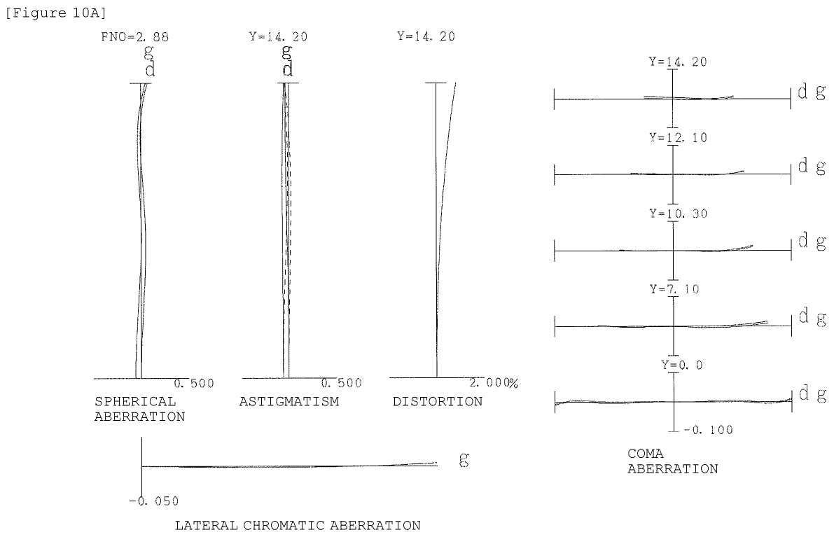

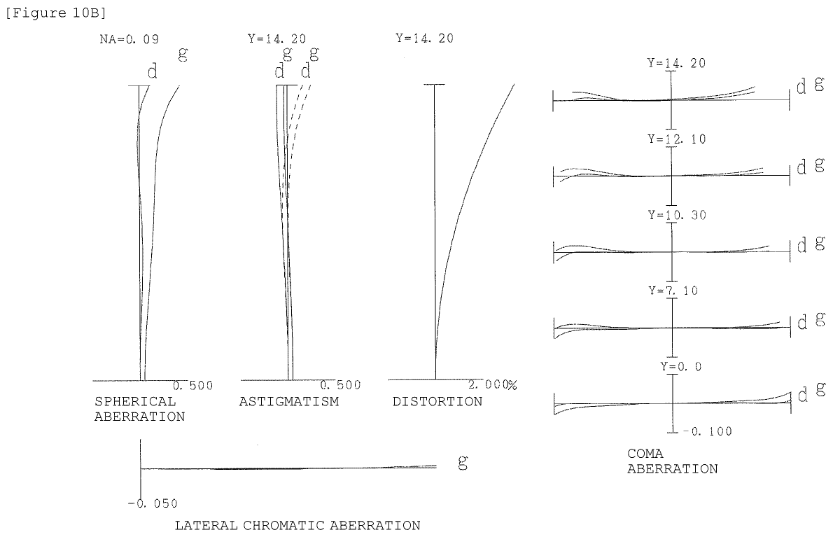

FIG. 10 shows a spherical aberration diagram, an astigmatism diagram, a distortion diagram, a lateral chromatic aberration diagram, and a coma aberration diagram of the optical system OL5 at focusing on an infinite distance object and at focusing on a close distance object. The aberration diagrams show that the optical system OL5 allows favorable correction of the variety of aberrations and has excellent imaging performance.

### Sixth Example

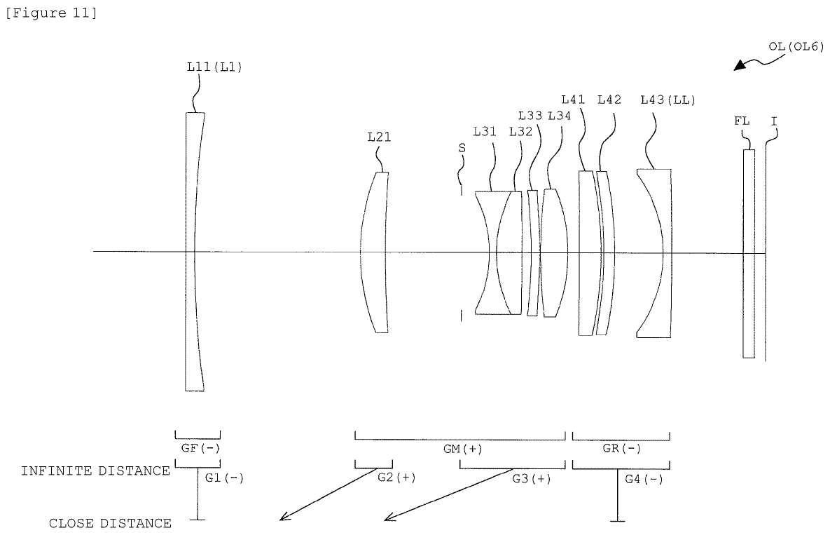

FIG. 11 is a diagram showing the configuration of the optical system OL6 according to a sixth example. The optical system OL6 includes, sequentially from the object side, a front group GF including a first lens group G1 having negative refractive power, an intermediate group GM including a second lens group G2 having positive refractive power and a third lens group G3 having positive refractive power and having positive refractive power as a whole, and a rear group GR including a fourth lens group G4 having negative refractive power.

The first lens group G1 includes a plano-concave negative lens L11 (L1) having a flat plane facing the object side. The second lens group G2 includes a positive lens L21 in a meniscus shape having a convex surface facing the object side. The third lens group G3 includes, sequentially from the object side, a cemented negative lens formed by cementing a biconcave negative lens L31 and a biconvex positive lens L32, a positive lens L33 in a meniscus shape having a concave surface facing the object side and formed with an aspheric lens surface on the image plane side, and a biconvex positive lens L34. The fourth lens group G4 includes, sequentially from the object side, a positive lens L41 in a meniscus shape having a concave surface facing the object side, a negative lens L42 in a meniscus shape having a concave surface facing the object side and formed with an aspheric lens surface on the object side, and a negative lens L43 (LL) in a meniscus shape having a concave surface facing the object side.

In the optical system OL6, an aperture stop S is disposed between the second lens group G2 and the third lens group G3 in the intermediate group GM. In addition, a filter group FL is disposed between the fourth lens group G4 and an image plane I.

In the optical system OL6, the second lens group G2 and the third lens group G3 as the intermediate group GM move to the object side on the optical axis at focusing on from an infinite distance object to a close distance object. The aperture stop S moves together with the third lens group G3 at focusing.

Table 15 below shows values of specifications of the optical system OL6.

TABLE 15
Sixth example
[Overall specifications]

| | |
|---|---|
| f = | 34.506 |
| Fno = | 1.87 |
| ω[°] = | 22.613 |
| Y = | 14.200 |
| TL = | 81.000 |
| TL (air-conversion length) = | 80.455 |
| BF = | 13.100 |
| BF (air-conversion length) = | 12.555 |

[Lens data]

| m | r | d | nd | vd | |
|---|---|---|---|---|---|
| Object plane | ∞ | | | | |
| 1 | ∞ | 1.2000 | 1.60342 | 38.03 | |
| 2 | 137.0000 | d1 | | | |
| 3 | 29.7763 | 3.5000 | 1.77250 | 49.62 | |
| 4 | 162.6784 | d2 | | | |
| 5 | ∞ | 3.9000 | | | Aperture stop S |
| 6 | −17.7201 | 1.0000 | 1.69895 | 30.13 | |
| 7 | 18.8264 | 3.6000 | 1.80400 | 46.60 | |
| 8 | −368.3266 | 1.3000 | | | |
| 9 | −70.0000 | 1.2000 | 1.53504 | 55.71 | |
| 10* | −63.1478 | 0.1000 | | | |
| 11 | 73.4674 | 3.8000 | 1.80400 | 46.60 | |
| 12 | −24.0859 | d3 | | | |
| 13 | −512.8175 | 3.0000 | 1.77250 | 49.62 | |
| 14 | −53.8371 | 0.4000 | | | |
| 15* | −52.0000 | 1.5000 | 1.53504 | 55.71 | |
| 16 | −55.8074 | 6.8350 | | | |
| 17 | −18.5196 | 1.2000 | 1.51742 | 52.20 | |
| 18 | −421.4731 | 10.0000 | | | |
| 19 | ∞ | 1.6000 | 1.51680 | 64.13 | |
| 20 | ∞ | 1.5000 | | | |
| Image plane | ∞ | | | | |

[Focal length of lens groups]

| Lens group | First surface | Focal length |
|---|---|---|
| Front group GF (First lens group G1) | 1 | −227.039 |
| Intermediate group GM | 3 | 33.771 |
| Second lens group G2 | 3 | 46.646 |
| Third lens group G3 | 6 | 43.983 |
| Rear group GR (Fourth lens group G4) | 13 | −82.053 |

In the optical system OL6, the tenth surface and the fifteenth surface are each formed in an aspheric shape. Table 16 below shows aspheric surface data, in other words, the values of the conic constant K and the aspheric surface constants A4 to A14.

TABLE 16
[Aspheric surface data]
Tenth surface
K = 1.00000

| | | |
|---|---|---|
| A4 = 4.22622E−05 | A6 = −2.61315E−07 | A8 = 1.23491E−08 |
| A10 = −2.58085E−10 | A12 = 2.70030E−12 | A14 = −1.11010E−14 |

Fifteenth surface
K = 1.00000

| | | |
|---|---|---|
| A4 = 7.42581E−06 | A6 = 4.99661E−08 | A8 = −2.94414E−10 |
| A10 = 1.20068E−12 | A12 = 0.00000E+00 | A14 = 0.00000E+00 |

In the optical system OL6, an on-axis air space d1 between the first lens group G1 and the second lens group G2, an on-axis air space d2 between the second lens group G2 and the third lens group G3, and an on-axis air space d3 between the third lens group G3 and the fourth lens group G4 change at focusing. Table 17 below shows variable spaces at focusing on an infinite distance object and at focusing on a close distance object.

TABLE 17
[Variable space data]

| | Infinite distance object | Close distance object |
|---|---|---|
| f | 34.506 | — |
| β | — | −0.70 |
| d1 | 23.1650 | 1.6000 |
| d2 | 10.6000 | 8.6232 |
| d3 | 1.6000 | 25.1418 |

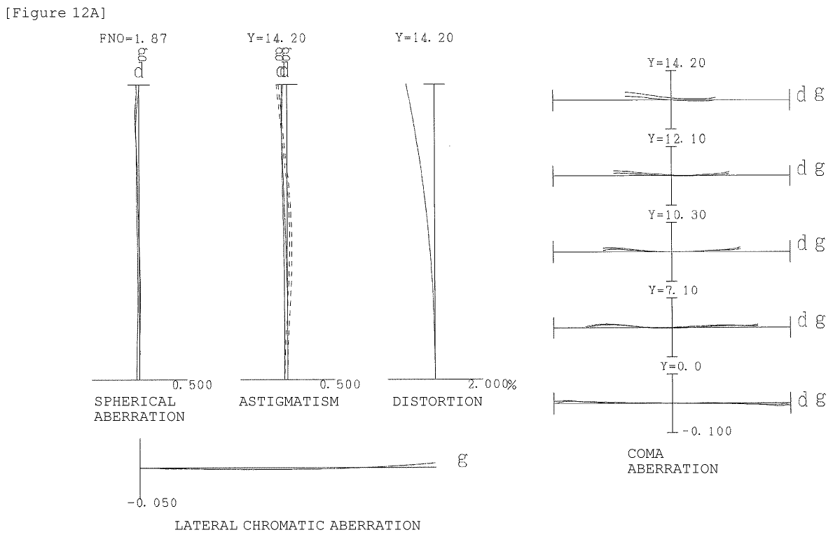

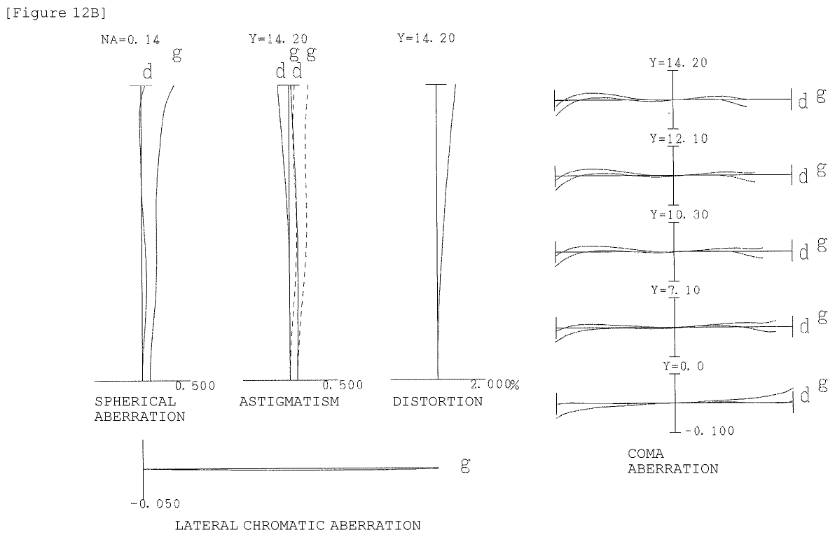

FIG. 12 shows a spherical aberration diagram, an astigmatism diagram, a distortion diagram, a lateral chromatic aberration diagram, and a coma aberration diagram of the optical system OL6 at focusing on an infinite distance object and at focusing on a close distance object. The aberration diagrams show that the optical system OL6 allows favorable correction of the variety of aberrations and has excellent imaging performance.

### Seventh Example

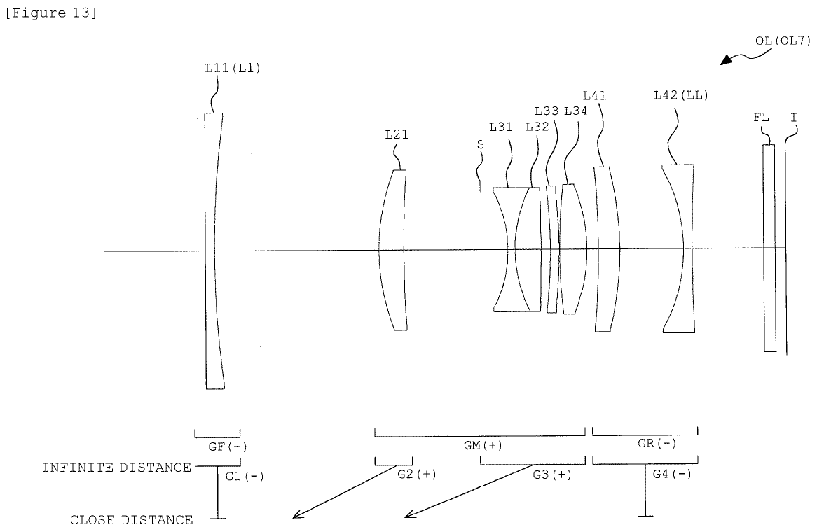

FIG. 13 is a diagram showing the configuration of the optical system OL7 according to a seventh example. The optical system OL7 includes, sequentially from the object side, a front group GF including a first lens group G1 having negative refractive power, an intermediate group GM including a second lens group G2 having positive refractive power and a third lens group G3 having positive refractive power and having positive refractive power as a whole, and a rear group GR including a fourth lens group G4 having negative refractive power.

The first lens group G1 includes a plano-concave negative lens L11 (L1) having a flat plane facing the object side. The second lens group G2 includes a positive lens L21 in a meniscus shape having a convex surface facing the object side. The third lens group G3 includes, sequentially from the object side, a cemented negative lens formed by cementing a biconcave negative lens L31 and a biconvex positive lens L32, a positive lens L33 in a meniscus shape having a concave surface facing the object side and formed with an aspheric lens surface on the image plane side, and a biconvex positive lens L34. The fourth lens group G4 includes, sequentially from the object side, a positive lens L41 in a meniscus shape having a concave surface facing the object side, and a biconcave negative lens L42 (LL).

In the optical system OL7, an aperture stop S is disposed between the second lens group G2 and the third lens group G3 in the intermediate group GM. In addition, a filter group FL is disposed between the fourth lens group G4 and an image plane I.

In the optical system OL7, the second lens group G2 and the third lens group G3 as the intermediate group GM move to the object side on the optical axis at focusing on from an infinite distance object to a close distance object. The aperture stop S moves together with the third lens group G3 at focusing.

Table 18 below shows values of specifications of the optical system OL7.

TABLE 18
Seventh example
[Overall specifications]

| | |
|---|---|
| f = | 34.809 |
| Fno = | 1.88 |
| ω[°] = | 22.33 |
| Y = | 14.200 |
| TL = | 81.000 |
| TL (air-conversion length) = | 80.455 |
| BF = | 13.100 |
| BF (air-conversion length) = | 12.555 |

[Lens data]

| m | r | d | nd | vd | |
|---|---|---|---|---|---|
| Object plane | ∞ | | | | |
| 1 | ∞ | 1.2000 | 1.60342 | 38.03 | |
| 2 | 137.0000 | d1 | | | |
| 3 | 30.2634 | 3.5000 | 1.77250 | 49.62 | |
| 4 | 163.9532 | d2 | | | |
| 5 | ∞ | 3.9000 | | | Aperture stop S |
| 6 | −17.5242 | 1.0000 | 1.69895 | 30.13 | |
| 7 | 19.2332 | 3.6000 | 1.80400 | 46.60 | |
| 8 | −338.5777 | 1.3000 | | | |
| 9 | −70.0000 | 1.2000 | 1.53504 | 55.71 | |
| 10* | −59.8040 | 0.1000 | | | |
| 11 | 78.4773 | 3.8000 | 1.80400 | 46.60 | |
| 12 | −23.8412 | d3 | | | |
| 13 | −125.6395 | 3.0000 | 1.77250 | 49.62 | |
| 14 | −46.8274 | 8.9114 | | | |
| 15 | −23.0295 | 1.2000 | 1.51742 | 52.20 | |
| 16 | 237.4580 | 10.0000 | | | |
| 17 | ∞ | 1.6000 | 1.51680 | 64.13 | |
| 18 | ∞ | 1.5000 | | | |
| Image plane | ∞ | | | | |

[Focal length of lens groups]

| Lens group | First surface | Focal length |
|---|---|---|
| Front group GF (First lens group G1) | 1 | −227.039 |
| Intermediate group GM | 3 | 34.000 |
| Second lens group G2 | 3 | 47.502 |
| Third lens group G3 | 6 | 44.102 |
| Rear group GR (Fourth lens group G4) | 13 | −82.712 |

In the optical system OL7, the tenth surface is formed in an aspheric shape. Table 19 below shows aspheric surface data, in other words, the values of the conic constant K and the aspheric surface constants A4 to A14.

TABLE 19
[Aspheric surface data]
Tenth surface
K = 1.00000

| | | |
|---|---|---|
| A4 = 4.27018E−05 | A6 = −3.39344E−07 | A8 = 1.47524E−08 |
| A10 = −2.99211E−10 | A12 = 3.04550E−12 | A14 = −1.22760E−14 |

In the optical system OL7, an on-axis air space d1 between the first lens group G1 and the second lens group G2, an on-axis air space d2 between the second lens group G2 and the third lens group G3, and an on-axis air space d3 between the third lens group G3 and the fourth lens group G4 change at focusing. Table 20 below shows variable spaces at focusing on an infinite distance object and at focusing on a close distance object.

TABLE 20
[Variable space data]

| | Infinite distance object | Close distance object |
|---|---|---|
| f | 34.809 | — |
| β | — | −0.70 |
| d1 | 22.9886 | 1.6000 |
| d2 | 10.6000 | 8.3141 |
| d3 | 1.6000 | 25.2745 |

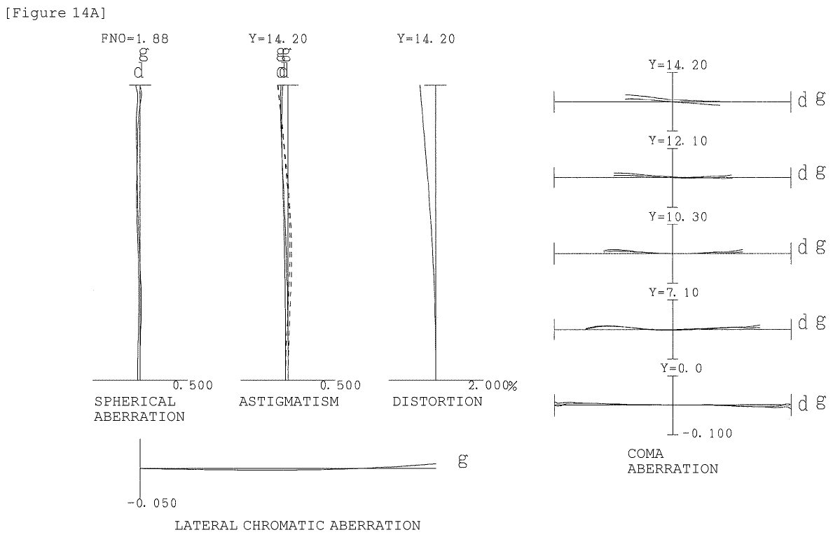

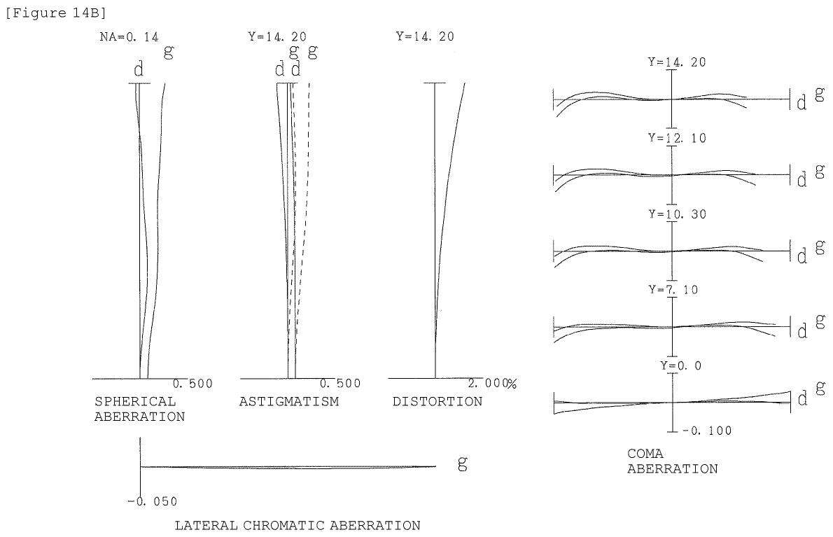

FIG. 14 shows a spherical aberration diagram, an astigmatism diagram, a distortion diagram, a lateral chromatic aberration diagram, and a coma aberration diagram of the optical system OL7 at focusing on an infinite distance object and at focusing on a close distance object. The aberration diagrams show that the optical system OL7 allows favorable correction of the variety of aberrations and has excellent imaging performance.

### [Conditional Expression Correspondence Value]

Table 21 below shows the correspondence values of Conditional Expressions (1) to (12) in the first to seventh examples.

TABLE 21

| | |
|---|---|
| (1) | d1/f |
| (2) | TL/DF |
| (3) | DM/DR |
| (4) | d1/TL |
| (5) | (DF + DM + DR)/DF |
| (6) | (1-βM²) × βR² |
| (7) | f/fF |
| (8) | fM/f |
| (9) | (-fR)/f |
| (10) | (-fR)/fM |
| (11) | BF/TL |
| (12) | f/fL1 |

| | | | | Fourth |
|---|---|---|---|---|
| | First example | Second example | Third example | example |
| (1) | 0.709 | 0.697 | 0.699 | 0.695 |
| (2) | 36.182 | 42.627 | 67.046 | 67.046 |
| (3) | 2.365 | 2.373 | 2.296 | 1.885 |
| (4) | 0.310 | 0.338 | 0.308 | 0.328 |
| (5) | 19.116 | 20.900 | 34.138 | 32.248 |
| (6) | 1.732 | 1.462 | 1.166 | 1.581 |
| (7) | 0.097 | 0.040 | 0.000 | −0.049 |
| (8) | 0.705 | 0.813 | 0.926 | 0.810 |
| (9) | 1.094 | 1.289 | 2.374 | 1.249 |
| (10) | 1.553 | 1.585 | 2.564 | 1.542 |
| (11) | 0.144 | 0.153 | 0.160 | 0.171 |
| (12) | 0.097 | 0.040 | 0.000 | −0.049 |
| | Fifth example | Sixth example | Seventh example | |
| (1) | 0.695 | 0.671 | 0.660 | |
| (2) | 67.046 | 67.046 | 67.046 | |
| (3) | 1.974 | 2.242 | 2.212 | |
| (4) | 0.331 | 0.288 | 0.286 | |
| (5) | 30.833 | 35.946 | 36.093 | |
| (6) | 1.634 | 1.133 | 1.135 | |
| (7) | −0.100 | −0.152 | −0.153 | |
| (8) | 0.807 | 0.979 | 0.977 | |
| (9) | 1.262 | 2.378 | 2.376 | |
| (10) | 1.563 | 2.430 | 2.433 | |
| (11) | 0.190 | 0.156 | 0.156 | |
| (12) | −0.100 | −0.152 | −0.153 | |

### REFERENCE SIGNS LIST

1 camera (optical apparatus)
OL (OL1 to OL7) optical system
GF front group
GM intermediate group
GR rear group
S aperture stop (aperture)

1. An optical system comprising a front group, an intermediate group, and a rear group sequentially from an object side, wherein
the intermediate group moves in an optical axis direction at focusing, and
the optical system satisfies a condition expressed by an expression below,
$$0.54 < d 1 / f < 1.$$
in the expression,
d1: distance on an optical axis from a lens surface closest to an image plane side in the front group to a lens surface closest to the object side in the intermediate group at focusing on an infinite distance object, and
f: overall focal length of the optical system at focusing on an infinite distance object.

2. An optical system comprising a front group, an intermediate group, and a rear group sequentially from an object side, wherein
the intermediate group moves in an optical axis direction at focusing, and
the optical system satisfies a condition expressed by expressions below,
$$32. < TL / DF < 80.$$
$$1. < DM / DR < 4.$$
in the expressions,
TL: optical total length of the optical system at focusing on an infinite distance object,
DF: distance on an optical axis from a lens surface closest to the object side to a lens surface closest to an image plane side in the front group,
DM: distance on the optical axis from a lens surface closest to the object side to a lens surface closest to the image plane side in the intermediate group at focusing on an infinite distance object, and
DR: distance on the optical axis from a lens surface closest to the object side to a lens surface closest to the image plane side in the rear group.

3. The optical system according to claim 1, wherein the optical system satisfies a condition expressed by an expression below,
$$0.2 < d 1 / TL < 0.4$$
in the expression,
d1: distance on an optical axis from a lens surface closest to an image plane side in the front group to a lens surface closest to the object side in the intermediate group at focusing on an infinite distance object, and
TL: optical total length of the optical system at focusing on an infinite distance object.

4. The optical system according to claim 1, wherein the optical system satisfies a condition expressed by an expression below,
$$17. < ( DF + DM + DR ) / DR < 40.$$
in the expression,
DF: distance on the optical axis from a lens surface closest to the object side to a lens surface closest to the image plane side in the front group,
DM: distance on the optical axis from a lens surface closest to the object side to a lens surface closest to the image plane side in the intermediate group at focusing on an infinite distance object, and
DR: distance on the optical axis from a lens surface closest to the object side to a lens surface closest to the image plane side in the rear group.

5. The optical system according to claim 1, wherein the optical system satisfies a condition expressed by an expression below,
$$0.8 < ( 1 - {β M}^{2} ) \times {β R}^{2} < 2.$$
in the expression,
βM: lateral magnification of the intermediate group at focusing on an infinite distance object, and
RR: lateral magnification of the rear group at focusing on an infinite distance object.

6. The optical system according to claim 1, wherein the optical system satisfies a condition expressed by an expression below,
$$- 0.5 < f / fF < 0.3$$
in the expression,
f: overall focal length of the optical system at focusing on an infinite distance object, and
fF: focal length of the front group.

7. The optical system according to claim 1, wherein a lens component disposed closest to the image plane side has negative refractive power.

8. The optical system according to claim 1, wherein the front group is constituted by one lens.

9. The optical system according to claim 1, comprising an aperture in the intermediate group, wherein the aperture moves in the optical axis direction at focusing.

10. The optical system according to claim 1, wherein the intermediate group has positive refractive power.

11. The optical system according to claim 1, wherein the rear group has negative refractive power.

12. The optical system according to claim 1, wherein the optical system satisfies a condition expressed by an expression below,
$$0.5 < fM / f < 1.1$$
in the expression,
fM: focal length of the intermediate group at focusing on an infinite distance object, and
f: overall focal length of the optical system at focusing on an infinite distance object.

13. The optical system according to claim 1, wherein the optical system satisfies a condition expressed by an expression below,
$$0.5 < ( - fR ) / f < 3.$$
in the expression,
fR: focal length of the rear group, and
f: overall focal length of the optical system at focusing on an infinite distance object.

14. The optical system according to claim 1, wherein the optical system satisfies a condition expressed by an expression below,
$$1. < ( - fR ) / fM < 3.$$
in the expression,
fR: focal length of the rear group, and
fM: focal length of the intermediate group at focusing on an infinite distance object.

15. The optical system according to claim 1, wherein the optical system satisfies a condition expressed by an expression below,
$$0.1 < BF / TL < 0.3$$
in the expression,
BF: back focus of the optical system at focusing on an infinite distance object, and
TL: optical total length of the optical system at focusing on an infinite distance object.

16. The optical system according to claim 1, wherein the optical system satisfies a condition expressed by an expression below,
$$- 0.4 < f / fL 1 < 0.3$$
in the expression,
f: overall focal length of the optical system at focusing on an infinite distance object, and
fL1: focal length of a lens component disposed closest to the object side.

17. An optical apparatus comprising the optical system according to claim 1.

18. A method for manufacturing an optical system including a front group, an intermediate group, and a rear group sequentially from an object side, the method comprising:
disposing the lens groups so that the intermediate group moves in an optical axis direction at focusing; and
disposing the lens groups so that a condition expressed by an expression below is satisfied,
$$0.54 < d 1 / f < 1.$$
in the expression,
d1: distance on an optical axis from a lens surface closest to an image plane side in the front group to a lens surface closest to the object side in the intermediate group at focusing on an infinite distance object, and
f: overall focal length of the optical system at focusing on an infinite distance object.

19. A method for manufacturing an optical system including a front group, an intermediate group, and a rear group sequentially from an object side, the method comprising:
disposing the lens groups so that the intermediate group moves in an optical axis direction at focusing, and
disposing the lens groups so that a condition expressed by expressions below is satisfied,
$$32. < TL / DF < 80.$$
$$1. < DM / DR < 4.$$
in the expressions,
TL: optical total length of the optical system at focusing on an infinite distance object,
DF: distance on an optical axis from a lens surface closest to the object side to a lens surface closest to an image plane side in the front group,
DM: distance on the optical axis from a lens surface closest to the object side to a lens surface closest to the image plane side in the intermediate group at focusing on an infinite distance object, and
DR: distance on the optical axis from a lens surface closest to the object side to a lens surface closest to the image plane side in the rear group.
